(19) United States
(12) Patent Application Publication
(10) Pub. No.: US 2021/0301147 A1
(43) Pub. Date: Sep. 30, 2021

(54) AQUEOUS BASECOAT AND PRODUCTION OF MULTI-COAT PAINT SYSTEMS USING THE BASECOAT

(71) Applicant: BASF Coatings GmbH, Munster (DE)

(72) Inventors: Juergen Bauer, Graefelfing (DE); Dirk Eierhoff, Muenster (DE); Katharina Fechtner, Muenster (DE); Hardy Reuter, Muenster (DE); Marita Buermann, Muenster (DE); Joerg Schwarz, Muenster (DE); Patrick Wilm, Muenster (DE)

(21) Appl. No.: 16/317,864

(22) PCT Filed: Jul. 12, 2017
(86) PCT No.: PCT/EP2017/067628

§ 371 Date: Jan. 15, 2019

(30) Foreign Application Priority Data
Jul. 15, 2016 (EP) 16179635.4

(51) Int. Cl. C09D 5/00; C09D 5/02; C09D 175/02; C09D 175/12; C09D 7/20; B05D 7/00

(52) U.S. Cl. CPC C09D 5/002; C09D 5/022; B05D 7/572; C09D 175/12; C09D 7/20; C09D 175/02

(57) ABSTRACT

Described herein is an aqueous basecoat material including at least one aqueous polyurethane-polyurea dispersion (PD) with polyurethane-polyurea particles present in the dispersion and having an average particle size of 40 to 2000 nm and a gel fraction of at least 50%, and also including at least one aqueous dispersion (wD) which includes a polymer prepared by a successive radical emulsion polymerization of three different mixtures (A), (B), and (C), of olefinically unsaturated monomers. Also described herein are multicoat paint systems produced using the basecoat materials.

### FIELD OF INVENTION

The present invention relates to an aqueous basecoat material. The present invention also relates to a method for producing a multicoat paint system that involves producing at least one basecoat film using at least one such aqueous basecoat material. The present invention further relates to a multicoat paint system produced by the method of the invention.

### BACKGROUND

Multicoat paint systems on metallic substrates or plastics substrates, examples being multicoat paint systems in the automobile industry sector, are known. Starting, conceptually, from the metallic substrate, multicoat paint systems of this kind on metallic substrates generally comprise a separately cured electrocoat film, a film which is applied directly to the electrocoat film and is cured separately, usually referred to as surfacer film, at least one film which comprises color pigments and/or effect pigments and is generally referred to as basecoat film, and a clearcoat film. Basecoat film and clearcoat film are generally cured jointly.

On plastics substrates, which are relevant in the sector of components for installation in or on vehicles, it is generally likewise the case that corresponding basecoat and clearcoat films are applied. In some cases, certain surfacers or adhesion primers are applied before the basecoat material is applied.

Particularly in connection with metal substrates, there are approaches which attempt to do without the separate step of curing the coating composition applied directly to the cured electrocoat film (that is, the coating composition referred to as surfacer within the standard method described above), and at the same time, optionally, to lower the film thickness of the coating film produced from this coating composition. Within the art, this coating film, which is therefore not separately cured, is then frequently called the basecoat film (and no longer a surfacer film) or, to distinguish it from a second basecoat film applied atop it, it is called the first basecoat film. In some cases an attempt is even made to do entirely without this coating film (in which case, then, merely one so-called basecoat film is produced directly on the electrocoat film, over which, without a separate curing step, a clearcoat material is applied; in other words, ultimately, a separate curing step is likewise omitted). In place of the separate curing step and of an additional concluding curing step, therefore, the intention is to have merely one, concluding curing step following application of all of the coating films applied to the electrocoat film.

Avoiding a separate curing step for the coating composition applied directly to the electrocoat film is very advantageous from environmental and economic standpoints. The reason is that it saves energy and allows the production operation as a whole to proceed with substantially less stringency, of course.

Similar methods are known in connection with plastics processes, in which of course no electrocoat film is produced. The system for joint curing, composed of first basecoat material, second basecoat material, and clearcoat material, is therefore applied, for example, directly to the plastics substrate, which may have been given a surface-activating pretreatment, or else to a surfacer film or adhesion primer film which has first been applied to the substrate.

Likewise known are refinish methods for the re-establishment of multicoat paint systems. These, then, are methods in which multicoat paint systems produced as described above, but possessing certain defects, are to be prepared. Such refinish methods take place, for example, by local repair of defects (spot repair), or by complete recoating of the original finish bearing the defects (dual finishing). In this case, in general, after local sanding of the defects, systems as described above, composed of surfacer, basecoat, and clearcoat or of first basecoat, second basecoat, clearcoat, are applied. Also possible is the application only of one basecoat and of a clearcoat applied thereto, followed by joint curing. In practice here, then, the multicoat paint system with defects (original finish) serves as substrate.

Although the technological properties of existing multicoat paint systems are already often sufficient to meet the specifications of the automobile manufacturers, there continues to be a need for them to be improved. This is so particularly in connection with the last-described method for producing multicoat paint systems, in which, as indicated, a separate curing step is omitted. Even the standard methods described earlier on above for producing multicoat paint systems, however, are still amenable to optimization in this respect.

A particular challenge is to provide multicoat paint systems with which firstly very good optical properties (for example, avoidance of popping marks or pinholes) are achieved, but also, secondly, an optimum mechanical resistance is achieved, and especially optimum adhesion properties. A prime challenge is to obtain good adhesion properties in the refinish sector.

The problem addressed with the present invention, accordingly, was that of providing a multicoat paint system, and/or coating compositions to be used in the production of such multicoat paint systems, which allow the disadvantages addressed above to be eliminated. The intention, then, is to make it possible for multicoat paint systems (original finishes) and also refinished multicoat paint systems to be provided which as well as excellent esthetic properties also have very good adhesion properties.

### DESCRIPTION

It has been found that the stated problems have been solved by an aqueous basecoat material comprising

at least one aqueous polyurethane-polyurea dispersion (PD) having polyurethane-polyurea particles present in the dispersion with an average particle size of 40 to 2000 nm and a gel fraction of at least 50%, where the polyurethane-polyurea particles, in each case in reacted form, comprise

(Z.1.1) at least one polyurethane prepolymer containing isocyanate groups and containing anionic groups and/or groups which can be converted into anionic groups, and

(Z.1.2) at least one polyamine containing two primary amino groups and one or two secondary amino group,
and also
at least one aqueous dispersion (wD) comprising a polymer having a particle size of 100 to 500 nm, and prepared by the successive radical emulsion polymerization of three different mixtures (A), (B), and (C), of olefinically unsaturated monomers,
where
a polymer prepared from the mixture (A) possesses a glass transition temperature of 10 to 65° C.,
a polymer prepared from the mixture (B) possesses a glass transition temperature of −35 to 15° C.,
and
a polymer prepared from the mixture (C) possesses a glass transition temperature of −50 to 15° C.

The aqueous basecoat material identified above will also be referred to below as basecoat material of the invention, and accordingly is subject matter of the present invention. Preferred embodiments of the basecoat material of the invention are evident from the description below and also from the dependent claims.

A further subject of the present invention is a method for producing a multicoat paint system wherein at least one basecoat film is produced using at least one aqueous basecoat material of the invention. The present invention relates, moreover, to a multicoat paint system which has been produced by the method of the invention.

Through the use of basecoat material of the invention, multicoat paint systems are obtained which have outstanding performance properties, especially excellent esthetic properties, and, moreover, very good adhesion properties. Using the basecoat material it is also possible for multicoat paint systems bearing defects to be refinished in a particularly high-grade way. In this refinishing sector as well, which is a particular challenge in relation to adhesion and mechanical resistance, an excellent profile of properties is achieved.

The aqueous basecoat material of the invention comprises at least one, preferably precisely one, specific aqueous polyurethane-polyurea dispersion (PD), this being a dispersion in which the polymer particles present are polyurethane-polyurea based. Such polymers are preparable in principle by conventional polyaddition of, for example, polyisocyanates with polyols and also polyamines. In relation to the dispersion (PD) of the invention, or to the polymer particles it contains, however, there are specific conditions to be met which are set out below.

The polyurethane-polyurea particles present in the aqueous polyurethane-polyurea dispersion (PD) possess a gel fraction of at least 50% (for measurement method see Examples section). Moreover, the polyurethane-polyurea particles present in the dispersion (PD) possess an average particle size (also called mean particle size) of 40 to 2000 nanometers (nm) (for measurement methods see Examples section).

The dispersions (PD) for use in accordance with the invention are therefore microgel dispersions. This is because, as already described above, a microgel dispersion comprises polymer dispersions in which firstly the polymer is present in the form of comparatively small particles, or microparticles, and secondly the polymer particles are at least partly intramolecularly crosslinked. The latter means that the polymer structures present within a particle equate to a typical macroscopic network with three-dimensional network structure. Viewed macroscopically, however, a microgel dispersion of this kind is still a dispersion of polymer particles in a dispersion medium, water for example. While the particles may also in part exhibit crosslinking bridges with one another (this can hardly be ruled out in view of the preparation process itself), the system is at any rate a dispersion having discrete particles present therein that have a measurable average particle size.

Given that the microgels represent structures which lie between branched and macroscopically crosslinked systems, and consequently combine the characteristics of macromolecules with network structure that are soluble in suitable organic solvents, and insoluble macroscopic networks, the fraction of the crosslinked polymers can be determined, for example, only after isolation of the solid polymer, after removal of water and any organic solvents, and following subsequent extraction. The characteristics exploited here are that the microgel particles, originally soluble in suitable organic solvents, retain their internal network structure after isolation, and behave like a macroscopic network in the solid material. The crosslinking can be verified via the experimentally accessible gel fraction. The gel fraction, ultimately, is that fraction of the polymer from the dispersion that, as an isolated solid, cannot be subjected to molecularly disperse dissolution in a solvent. In that case it must be concluded that, during the isolation of the polymeric solid, subsequent crosslinking reactions increase the gel fraction further. This insoluble fraction corresponds in turn to the fraction of the polymer present in the dispersion in the form of intramolecularly crosslinked particles and/or particle fractions.

In the context of the present invention it has emerged that only microgel dispersions having polymer particles with particle sizes in the range essential to the invention have all of the required performance properties. The important thing, then, in particular is the combination of very low particle sizes with a nevertheless significant crosslinked fraction or gel fraction. Only in this way is it possible to achieve the advantageous properties, especially the combination of good optical and mechanical properties of multicoat paint systems.

The polyurethane-polyurea particles present in the aqueous polyurethane-polyurea dispersion (PD) preferably possess a gel fraction of at least 60%, more preferably of at least 70%, especially preferably of at least 80%. The gel fraction may therefore be up to 100% or approximately 100%, as for example 99% or 98%. In such a case, therefore, the entire—or almost the entire—polyurethane-polyurea polymer is in the form of crosslinked particles.

The polyurethane-polyurea particles present in the dispersion (PD) possess preferably an average particle size of 40 to 1500 nm, more preferably of 100 to 1000 nm, further preferably of 110 to 500 nm, and additionally preferably 120 to 300 nm. An especially preferred range is from 130 to 250 nm.

The polyurethane-polyurea dispersion (PD) obtained is aqueous. The expression “aqueous” is known to the skilled person in this context. It refers fundamentally to a system whose dispersion medium does not exclusively or primarily contain organic solvents (also called dissolution agents), but instead, in contrast, comprises as its dispersion medium a significant fraction of water.

Preferred embodiments of aqueous character which are defined using the maximum amount of organic solvents and/or using the amount of water are described later on below for different components and systems, as for example dispersions (PD), dispersions (wD), or basecoat materials. The polyurethane-polyurea particles present in the dispersion (PD) comprise, in each case in reacted form, (Z.1.1) at least one polyurethane prepolymer containing isocyanate groups and comprising anionic groups and/or groups which can be converted into anionic groups, and also (Z.1.2) at least one polyamine comprising two primary amino groups and one or two secondary amino groups.

Where it is stated in the context of the present invention that polymers, such as the polyurethane-polyurea particles of the dispersion (PD), for example, comprise particular components in reacted form, this means that these particular components are used as starting compounds in the preparation of the polymers in question. Depending on the nature of the starting compounds, the particular reaction to give the target polymer takes place according to different mechanisms. Evidently, then, in the preparation of polyurethane-polyurea particles or polyurethane-polyurea polymers, the components (Z.1.1) and (Z.1.2) are reacted with one another through reaction of the isocyanate groups of (Z.1.1) with the amino groups of (Z.1.2) to form urea bonds. The polymer then of course comprises the amino groups and isocyanate groups, present beforehand, in the form of urea groups—that is, in their correspondingly reacted form. Ultimately, nevertheless, the polymer comprises the two components (Z.1.1) and (Z.1.2), since aside from the reacted isocyanate groups and amino groups, the components remain unchanged. For ease of comprehension, accordingly, it is said that the polymer in question comprises the components, in each case in reacted form. The meaning of the expression “the polymer comprises a component (X) in reacted form” can therefore be equated with the meaning of the expression “in the preparation of the polymer, component (X) was used”.

The polyurethane-polyurea particles preferably consist of the two components (Z.1.1) and (Z.1.2)—that is, they are prepared from these two components.

The aqueous dispersion (PD) may for example be obtained by a specific three-stage process. As part of the description of this process, preferred embodiments of the components (Z.1.1) and (Z.1.2) are stated as well.

In a first step (I) of this process, a specific composition (Z) is prepared.

The composition (Z) comprises at least one, preferably precisely one, specific isocyanate group-containing intermediate (Z.1) having blocked primary amino groups.

The preparation of the intermediate (Z.1) comprises the reaction of at least one of the polyurethane prepolymer (Z.1.1) containing isocyanate groups and comprising anionic groups and/or groups which can be converted into anionic groups, with at least one polyamine (Z.1.2a) that is derived from a polyamine (Z.1.2) and that comprises at least two blocked primary amino groups and at least one free secondary amino group.

Polyurethane polymers containing isocyanate groups and comprising anionic groups and/or groups which can be converted into anionic groups are known in principle. In the context of the present invention, for greater ease of comprehension, the component (Z.1.1) is referred to as prepolymer. This is because it is a polymer to be identified as a precursor, being used as a starting component for the preparation of another component, namely the intermediate (Z.1).

For the preparation of the polyurethane prepolymers (Z.1.1) containing isocyanate groups and comprising anionic groups and/or groups which can be converted into anionic groups, it is possible to use the aliphatic, cycloaliphatic, aliphatic-cycloaliphatic, aromatic, aliphatic-aromatic and/or cycloaliphatic-aromatic polyisocyanates that are known to the skilled person. Preference is given to using diisocyanates. The following diisocyanates may be stated by way of example: 1,3- or 1,4-phenylene diisocyanate, 2,4- or 2,6-tolylene diisocyanate, 4,4′- or 2,4′-diphenylmethane diisocyanate, 1,4- or 1,5-naphthylene diisocyanate, diisocyanatodiphenyl ether, trimethylene diisocyanate, tetramethylene diisocyanate, ethylethylene diisocyanate, 2,3-dimethylethylene diisocyanate, 1-methyltrimethylene diisocyanate, pentamethylene diisocyanate, 1,3-cyclopentylene diisocyanate, hexamethylene diisocyanate, cyclohexylene diisocyanate, 1,2-cyclohexylene diisocyanate, octamethylene diisocyanate, trimethylhexane diisocyanate, tetramethylhexane diisocyanate, decamethylene diisocyanate, dodecamethylene diisocyanate, tetradecamethylene diisocyanate, isophorone diisocyanate (IPDI), 2-isocyanato-propylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-1-methylcyclohexane, 1-isocyanatomethyl-5-isocyanato-1,3,3-trim ethylcyclohexane, 2,3-bis(8-isocyanatooctyl)-4-octyl-5-hexylcyclohexene, tetramethylxylylene diisocyanates (TMXDI) such as m-tetramethylxylylene diisocyanate, or mixtures of these polyisocyanates. Also possible, of course, is the use of different dimers and trimers of the stated diisocyanates such as uretdiones and isocyanurates. Preference is given to the use of aliphatic diisocyanates, such as hexamethylene diisocyanate, isophorone diisocyanate (IPDI), dicyclohexylmethane 4,4′-diisocyanate, 2,4- or 2,6-diisocyanato-1-methylcyclohexane, and/or m-tetramethylxylylene diisocyanate (m-TMXDI). An isocyanate is termed aliphatic when the isocyanate groups are attached to aliphatic groups—in other words, there is no aromatic carbon in alpha-position to an isocyanate group.

For the preparation of the prepolymers (Z.1.1), the polyisocyanates are generally reacted with polyols, more particularly diols, with formation of urethanes.

Examples of suitable polyols are saturated or olefinically unsaturated polyester polyols and/or polyether polyols. Used in particular as polyols are polyester polyols, especially those having a number-average molecular weight of 400 to 5000 g/mol (for measurement method see Examples section). Polyester polyols, preferably polyester diols, of this kind may be prepared in a known way by reaction of corresponding polycarboxylic acids, preferably dicarboxylic acids, and/or their anhydrides, with corresponding polyols, preferably diols, by esterification. Of course it is also possible optionally, additionally, to make proportional use of monocarboxylic acids and/or monoalcohols for the preparation procedure. The polyester diols are preferably saturated, more particularly saturated and linear.

Examples of suitable aromatic polycarboxylic acids for the preparation of such polyester polyols, preferably polyester diols, are phthalic acid, isophthalic acid, and terephthalic acid, of which isophthalic acid is advantageous and is therefore used with preference. Examples of suitable aliphatic polycarboxylic acids are oxalic acid, malonic acid, succinic acid, glutaric acid, adipic acid, pimelic acid, suberic acid, azelaic acid, sebacic acid, undecanedicarboxylic acid, and dodecanedicarboxylic acid, or else hexahydrophthalic acid, 1,3-cyclohexanedicarboxylic acid, 1,4-cyclohexanedicarboxylic acid, 4-methylhexahydrophthalic acid, tricyclodecanedicarboxylic acid, and tetra-hydrophthalic acid. As dicarboxylic acids it is likewise possible to use dimer fatty acids, or dimerized fatty acids, which, as is known, are mixtures prepared by dimerization of unsaturated fatty acids and are available under the trade names Radiacid (from Oleon) or Pripol (from Croda), for example. Using dimer fatty acids of these kinds to prepare polyester diols is preferred in the context of the present invention. Polyols used with preference for preparing the prepolymers (Z.1.1) are therefore polyester diols which have been prepared using dimer fatty acids. Especially preferred are those polyester diols in whose preparation at least 50 wt %, preferably 55 to 75 wt %, of the dicarboxylic acids used are dimer fatty acids.

Examples of corresponding polyols for the preparation of polyester polyols, preferably polyester diols, are ethylene glycol, 1,2-, or 1,3-propanediol, 1,2-, 1,3-, or 1,4-butanediol, 1,2-, 1,3-, 1,4-, or 1,5-pentanediol, 1,2-, 1,3-, 1,4-, 1,5-, or 1,6-hexanediol, neopentyl hydroxypivalate, neopentyl glycol, diethylene glycol, 1,2-, 1,3-, or 1,4-cyclohexanediol, 1,2-, 1,3-, or 1,4-cyclohexanedimethanol, and trimethylpentanediol. Preference is therefore given to using diols. Such polyols or diols may of course also be used directly to prepare the prepolymer (Z.1.1), in other words reacted directly with polyisocyanates.

For preparing the prepolymers (Z.1.1) it is also possible, furthermore, to use polyamines such as diamines and/or amino alcohols. Examples of diamines include hydrazine, alkyl- or cycloalkyldiamines such as propylenediamine and 1-amino-3-aminomethyl-3,5,5-trimethylcyclohexane, and examples of amino alcohols include ethanolamine or diethanolamine.

The prepolymers (Z.1.1) comprise anionic groups and/or groups which can be converted into anionic groups (that is, groups which can be converted into anionic groups through the use of known neutralizing agents which are also identified later on below such as bases). As the skilled person is aware, these are, for example, carboxylic, sulfonic and/or phosphonic acid groups, especially preferably carboxylic acid groups (functional groups which can be converted into anionic groups by neutralizing agents), and also anionic groups derived from the aforesaid functional groups, such as, in particular, carboxylate, sulfonate and/or phosphonate groups, preferably carboxylate groups. The effect of introducing such groups, as is known, is to increase the water-dispersibility. Depending on conditions selected, a proportion or virtually all of the groups identified may be present in one form (carboxylic acid, for example) or the other form (carboxylate). A certain influencing factor lies, for example, in the use of the aforementioned neutralizing agents, which are described in more detail later below. If the prepolymer (Z.1.1) is mixed with such neutralizing agents, then, depending on the amount of the neutralizing agent, a corresponding amount of the carboxylic acid groups will be converted into carboxylate groups. Irrespective of the form in which said groups are present, however, a uniform naming is frequently selected for the purposes of the present invention, to aid comprehension. Where, for example, a particular acid number is specified for a polymer, such as for a prepolymer (Z.1.1), or where such a polymer is termed carboxy-functional, the phrase always embraces not only the carboxylic acid groups but also the carboxylate groups. If there is to be any differentiation in this respect, this is done, for example, using the degree of neutralization.

For the purpose of introducing said groups it is possible, during the preparation of the prepolymers (Z.1.1), to use starting compounds which as well as groups for reaction in the production of urethane bonds, preferably hydroxyl groups, further comprise the abovementioned groups, carboxylic acid groups for example. In this way the groups in question are introduced into the prepolymer.

Corresponding compounds contemplated for introducing the preferred carboxylic acid groups are—insofar as they contain carboxyl groups—polyether polyols and/or polyester polyols. Preference, however, is given to using compounds that are at any rate of low molecular mass, and that have at least one carboxylic acid group and at least one functional group which is reactive toward isocyanate groups, hydroxyl groups being preferred. The expression “low molecular mass compound” for the purposes of the present invention means that in contrast to compounds of relatively high molecular mass, more particularly polymers, the compounds in question are those which can be assigned a discrete molecular weight, as preferably monomeric compounds. A low molecular mass compound, then, is in particular not a polymer, since the latter always constitute a mixture of molecules and must be described using average molecular weights. The term “low molecular mass compound” means preferably that the compounds in question have a molecular weight of less than 300 g/mol. The range from 100 to 200 g/mol is preferred.

Compounds preferred in this sense are, for example, monocarboxylic acids comprising two hydroxyl groups, such as dihydroxypropionic acid, dihydroxysuccinic acid, and dihydroxybenzoic acid, for example. Very particular are alpha,alpha-dimethylolalkanoic acids such as 2,2-dimethylolacetic acid, 2,2-dimethylolpropionic acid, 2,2-dimethylolbutyric acid, and 2,2-dimethylolpentanoic acid, especially 2,2-dimethylolpropionic acid.

The prepolymers (Z.1.1) are therefore preferably carboxy-functional. Based on the solids content, they possess an acid number of preferably 10 to 35 mg KOH/g, more particularly 15 to 23 mg KOH/g (for measurement method see Examples section).

The number-average molecular weight of the prepolymers may vary widely and is situated for example in the range from 2000 to 20 000 g/mol, preferably from 3500 to 6000 g/mol (for measurement method see Examples section).

The prepolymer (Z.1.1) contains isocyanate groups. Based on the solids content, it preferably possesses an isocyanate content of 0.5 to 6.0 wt %, preferably 1.0 to 5.0 wt %, especially preferably 1.5 to 4.0 wt % (for measurement method see Examples section).

Since the prepolymer (Z.1.1) contains isocyanate groups, the hydroxyl number of the prepolymer will obviously be very low as a general rule. The hydroxyl number of the prepolymer, based on the solids content, is preferably less than 15 mg KOH/g, more particularly less than 10 mg KOH/g, and with further preference less than 5 mg KOH/g (for measurement method see Examples section).

The prepolymers (Z.1.1) may be prepared by known and established methods in bulk or in solution, especially preferably by reaction of the starting compounds in organic solvents, such as methyl ethyl ketone for preference, at temperatures of, for example, 60 to 120° C., and optionally with use of catalysts typical for polyurethane preparation. Such catalysts are known to the skilled person; an example is dibutyltin laurate. The procedure here is of course to select the ratio of the starting components such that the product—that is, the prepolymer (Z.1.1)—comprises isocyanate groups. It is likewise immediately apparent that the solvents ought to be selected such that they do not enter into any unwanted reactions with the functional groups of the starting compounds, in other words being inert with respect to these groups to an extent such that they do not hinder the reaction of these functional groups. The preparation is preferably carried out already in an organic solvent (Z.2) as described later on below, since this solvent is required in any case to be present in the composition (Z) to be prepared in stage (I) of the process.

As is already indicated above, the groups which are present in the prepolymer (Z.1.1) and which can be converted into anionic groups may also be present proportionally as correspondingly anionic groups, as a result of the use of a neutralizing agent, for example. In this way it is possible to adjust the water-dispersibility of the prepolymers (Z.1.1) and hence also of the intermediate (Z.1).

Neutralizing agents contemplated include, in particular, the known basic neutralizing agents such as, for example, carbonates, hydrogencarbonates, or hydroxides of alkali metals and alkaline earth metals, such as LiOH, NaOH, KOH, or Ca(OH)₂, for example. Likewise suitable for neutralization and used with preference in the context of the present invention are organic bases containing nitrogen, such as amines such as ammonia, trimethylamine, triethylamine, tributylamines, dimethylaniline, triphenylamine, dimethylethanolamine, methyldiethanolamine, or triethanolamine, and also mixtures thereof.

The neutralization of the prepolymer (Z.1.1) with the neutralizing agents, more particularly with the organic bases containing nitrogen, may take place after the preparation of the prepolymer in organic phase, in other words in solution with an organic solvent, more particularly with a solvent (Z.2) as described below. The neutralizing agent may of course also be added as early as during or before the start of the actual polymerization, in which case, for example, the starting compounds containing carboxylic acid groups are then neutralized.

If neutralization is desired for the groups which can be converted into anionic groups, more particularly for the carboxylic acid groups, the neutralizing agent may be added, for example, in an amount such that a fraction of 35% to 65% of the groups is neutralized (degree of neutralization). Preferred is a range from 40% to 60% (for calculation method see Examples section).

It is preferred for the prepolymer (Z.1.1) to be neutralized after its preparation and before its use for the preparation of the intermediate (Z.1), as described.

The herein-described preparation of the intermediate (Z.1) encompasses the reaction of the described prepolymer (Z.1.1) with at least one, preferably precisely one, polyamine (Z.1.2a) derived from a polyamine (Z.1.2).

The polyamine (Z.1.2a) comprises two blocked primary amino groups and one or two free secondary amino groups.

Blocked amino groups, as is known, are those in which the hydrogen radicals on the nitrogen, that are present inherently in free amino groups, are substituted by reversible reaction with a blocking agent. By virtue of the blocking, the amino groups cannot be reacted, as can free amino groups, by condensation or addition reactions, and in this respect are therefore unreactive and hence differ from free amino groups. Only the removal of the reversibly adducted blocking agent again, thereby restoring the free amino groups, then allows, obviously, the conventional reactions of the amino groups. The principle therefore resembles the principle of masked or blocked isocyanates, which are likewise known within the field of polymer chemistry.

The primary amino groups of the polyamine (Z.1.2a) may be blocked with the conventional blocking agents, such as with ketones and/or aldehydes, for example. Such blocking then produces, with release of water, ketimines and/or aldimines, which no longer contain any nitrogen-hydrogen bonds, thereby preventing any typical condensation or addition reactions of an amino group with another functional group such as an isocyanate group.

Reaction conditions for preparing a blocked primary amine of this kind, such as a ketimine, for example, are known. Thus, for example, such blocking may be realized with supply of heat to a mixture of a primary amine with an excess of a ketone that functions simultaneously as a solvent for the amine. The water of reaction produced is preferably removed during the reaction, in order to prevent the otherwise possible reverse reaction (deblocking) of the reversible blocking.

The reaction conditions for the deblocking of blocked primary amino groups are also known per se. Thus, for example, the simple transfer of a blocked amine to the aqueous phase is sufficient for the equilibrium to be shifted back to the side of deblocking, as a result of the concentration pressure then exerted by the water, and so to produce free primary amino groups and also a free ketone, with consumption of water.

It follows from what has been said above that a clear distinction is made in the context of the present invention between blocked and free amino groups. Where, however, an amino group is specified neither as blocked nor as free, the reference is to a free amino group.

Preferred blocking agents for blocking the primary amino groups of the polyamine (Z.1.2a) are ketones. Among the ketones, particular preference is given to those which constitute an organic solvent (Z.2) as described later on below. The reason is that these solvents (Z.2) must in any case be present in the composition (Z) to be prepared in stage (I) of the process. It has already been indicated above that the preparation of such primary amines blocked with a ketone is accomplished to particularly good effect in an excess of the ketone. Through the use of ketones (Z.2) for the blocking, therefore, it is possible to employ the correspondingly preferred preparation procedure for blocked amines, without any need for costly and inconvenient removal of the possibly unwanted blocking agent. Instead, the solution of the blocked amine can be used directly to prepare the intermediate (Z.1). Preferred blocking agents are acetone, methyl ethyl ketone, methyl isobutyl ketone, diisopropyl ketone, cyclopentanone, or cyclohexanone; particularly preferred are the (Z.2) ketones methyl ethyl ketone and methyl isobutyl ketone.

The preferred blocking with ketones and/or aldehydes, especially ketones, and the accompanying preparation of ketimines and/or aldimines, moreover, has the advantage that primary amino groups selectively are blocked. Secondary amino groups present can obviously not be blocked, and therefore remain free. Accordingly it is possible to prepare a polyamine (Z.1.2a) which as well as the two blocked primary amino groups also comprises one or two free secondary amino groups in a trouble-free way via the stated preferred blocking reactions from a corresponding polyamine (Z.1.2) which comprises free secondary and primary amino groups.

The polyamines (Z.1.2a) may be prepared by blocking the primary amino groups of polyamines (Z.1.2) comprising two primary amino groups and one or two secondary amino groups. Suitable ultimately are all conventional aliphatic, aromatic, or araliphatic (mixed aliphatic-aromatic) polyamines (Z.1.2) having two primary amino groups and one or two secondary amino groups. This means that as well as the stated amino groups, there may be inherently arbitrary aliphatic, aromatic, or araliphatic groups present. Possible examples include monovalent groups, arranged as terminal groups on a secondary amino group, or divalent groups, arranged between two amino groups.

Organic groups are considered aliphatic in the context of the present invention if they are not aromatic. For example, the groups present in addition to the stated amino groups may be aliphatic hydrocarbon groups, these being groups which consist exclusively of carbon and hydrogen and are not aromatic. These aliphatic hydrocarbon groups may be linear, branched or cyclic, and may be saturated or unsaturated. These groups, of course, may also comprise cyclic and linear or branched components. A further possibility is for aliphatic groups to include heteroatoms, especially in the form of bridging groups such as ether, ester, amide and/or urethane groups. Possible aromatic groups are likewise known and require no further elucidation.

The polyamines (Z.1.2a) preferably possess two blocked primary amino groups and one or two free secondary amino groups, and they preferably possess, as primary amino groups, exclusively blocked primary amino groups and, as secondary amino groups, exclusively free secondary amino groups.

In total the polyamines (Z.1.2a) preferably possess three or four amino groups, these groups being selected from the group of the blocked primary amino groups and of the free secondary amino groups.

Especially preferred polyamines (Z.1.2a) are those which consist of two blocked primary amino groups, one or two free secondary amino groups, and also aliphatic-saturated hydrocarbon groups.

Analogous preferred embodiments are valid for the polyamines (Z.1.2), which then contain free primary amino groups rather than blocked primary amino groups.

Examples of preferred polyamines (Z.1.2) from which it is also possible, by blocking of the primary amino groups, to prepare polyamines (Z.1.2a) are diethylenetriamine, 3-(2-am inoethyl)aminopropylamine, dipropylenetriamine, and also N1-(2-(4-(2-amino-ethyl)piperazin-1-yl)ethyl)ethane-1,2-diamine (one secondary amino group, two primary amino groups for blocking) and triethylenetetramine, and also N,N′-bis(3-aminopropyl)-ethylenediamine (two secondary amino groups, two primary amino groups for blocking).

To the skilled person it is clear that not least for reasons associated with pure technical synthesis, there cannot always be a theoretically idealized quantitative conversion in the blocking of primary amino groups. For example, if a particular amount of a polyamine is blocked, the proportion of the primary amino groups that are blocked in the blocking process may be, for example, 95 mol % or more (determinable by IR spectroscopy; see Examples section). Where a polyamine in the nonblocked state, for example, possesses two free primary amino groups, and where the primary amino groups of a certain quantity of this amine are then blocked, it is said in the context of the present invention that this amine has two blocked primary amino groups if a fraction of more than 95 mol % of the primary amino groups present in the quantity employed are blocked. This is due on the one hand to the fact, already stated, that from a technical synthesis standpoint, a quantitative conversion cannot always be realized. On the other hand, the fact that more than 95 mol % of the primary amino groups are blocked means that the major fraction of the total amount of the amines used for blocking does in fact contain exclusively blocked primary amino groups, specifically exactly two blocked primary amino groups.

The preparation of the intermediate (Z.1) involves the reaction of the prepolymer (Z.1.1) with the polyamine (Z.1.2) by addition reaction of isocyanate groups from (Z.1.1) with free secondary amino groups from (Z.1.2). This reaction, which is known per se, then leads to the attachment of the polyamine (Z.1.2a) onto the prepolymer (Z.1.1), with formation of urea bonds, ultimately forming the intermediate (Z.1). It will be readily apparent that in the preparation of the intermediate (Z.1), preference is thus given to not using any other amines having free or blocked secondary or free or blocked primary amino groups.

The intermediate (Z.1) can be prepared by known and established techniques in bulk or solution, especially preferably by reaction of (Z.1.1) with (Z.1.2a) in organic solvents. It is immediately apparent that the solvents ought to be selected in such a way that they do not enter into any unwanted reactions with the functional groups of the starting compounds, and are therefore inert or largely inert in their behavior toward these groups. As solvent in the preparation, preference is given to using, at least proportionally, an organic solvent (Z.2) as described later on below, especially methyl ethyl ketone, even at this stage, since this solvent must in any case be present in the composition (Z) to be prepared in stage (I) of the process. With preference a solution of a prepolymer (Z.1.1) in a solvent (Z.2) is mixed here with a solution of a polyamine (Z.1.2a) in a solvent (Z.2), and the reaction described can take place.

Of course, the intermediate (Z.1) thus prepared may be neutralized during or after the preparation, using neutralizing agents already described above, in the manner likewise described above for the prepolymer (Z.1.1). It is nevertheless preferred for the prepolymer (Z.1.1) to be already neutralized prior to its use for preparing the intermediate (Z.1), in a manner described above, so that neutralization during or after the preparation of (Z.1) is no longer relevant. In such a case, therefore, the degree of neutralization of the prepolymer (Z.1.1) can be equated with the degree of neutralization of the intermediate (Z.1). So where there is no further addition of neutralizing agents at all in the context of the process, accordingly, the degree of neutralization of the polymers present in the ultimately prepared dispersions (PD) of the invention can also be equated with the degree of neutralization of the prepolymer (Z.1.1).

The intermediate (Z.1) possesses blocked primary amino groups. This can evidently be achieved in that the free secondary amino groups are brought to reaction in the reaction of the prepolymer (Z.1.1) and of the polyamine (Z.1.2a), but the blocked primary amino groups are not reacted. Indeed, as already described above, the effect of the blocking is that typical condensation reactions or addition reactions with other functional groups, such as isocyanate groups, are unable to take place. This of course means that the conditions for the reaction should be selected such that the blocked amino groups also remain blocked, in order thereby to provide an intermediate (Z.1). The skilled person knows how to set such conditions, which are brought about, for example, by reaction in organic solvents, which is preferred in any case.

The intermediate (Z.1) contains isocyanate groups. Accordingly, in the reaction of (Z.1.1) and (Z.1.2a), the ratio of these components must of course be selected such that the product—that is, the intermediate (Z.1)—contains isocyanate groups.

Since, as described above, in the reaction of (Z.1.1) with (Z.1.2a), free secondary amino groups are reacted with isocyanate groups, but the primary amino groups are not reacted, owing to the blocking, it is thus first of all immediately clear that in this reaction the molar ratio of isocyanate groups from (Z.1.1) to free secondary amino groups from (Z.1.2a) must be greater than 1. This feature arises implicitly, nevertheless clearly and directly from the feature essential to the invention, namely that the intermediate (Z.1) contains isocyanate groups.

It is nevertheless preferred for there to be an excess of isocyanate groups, defined as below, during the reaction. The molar amounts (n) of isocyanate groups, free secondary amino groups, and blocked primary amino groups, in this preferred embodiment, satisfy the following condition: [n (isocyanate groups from (Z.1.1))−n (free secondary amino groups from (Z.1.2a))]/n (blocked primary amino groups from (Z.1.2a))=1.2/1 to 4/1, preferably 1.5/1 to 3/1, very preferably 1.8/1 to 2.2/1, even more preferably 2/1.

In these preferred embodiments, the intermediate (Z.1), formed by reaction of isocyanate groups from (Z.1.1) with the free secondary amino groups from (Z.1.2a), possesses an excess of isocyanate groups in relation to the blocked primary amino groups. This excess is ultimately achieved by selecting the molar ratio of isocyanate groups from (Z.1.1) to the total amount of free secondary amino groups and blocked primary amino groups from (Z.1.2a) to be large enough that even after the preparation of (Z.1) and the corresponding consumption of isocyanate groups by the reaction with the free secondary amino groups, there remains a corresponding excess of the isocyanate groups.

Where, for example, the polyamine (Z.1.2a) has one free secondary amino group and two blocked primary amino groups, the molar ratio between the isocyanate groups from (Z.1.1) to the polyamine (Z.1.2a) in the very especially preferred embodiment is set at 5/1. The consumption of one isocyanate group in the reaction with the free secondary amino group would then mean that 4/2 (or 2/1) is realized for the condition stated above.

The fraction of the intermediate (Z.1) is from 15 to 65 wt %, preferably from 25 to 60 wt %, more preferably from 30 to 55 wt %, especially preferably from 35 to 52.5 wt %, and, in one very particular embodiment, from 40 to 50 wt %, based in each case on the total amount of the composition (Z).

Determining the fraction of an intermediate (Z.1) may be carried out as follows: The solids content of a mixture which besides the intermediate (Z.1) contains only organic solvents is ascertained (for measurement method for determining the solids (also called solids content, see Examples section). The solids content then corresponds to the amount of the intermediate (Z.1). By taking account of the solids content of the mixture, therefore, it is possible to determine or specify the fraction of the intermediate (Z.1) in the composition (Z). Given that the intermediate (Z.1) is preferably prepared in an organic solvent anyway, and therefore, after the preparation, is in any case present in a mixture which comprises only organic solvents apart from the intermediate, this is the technique of choice.

The composition (Z) further comprises at least one specific organic solvent (Z.2).

The solvents (Z.2) possess a solubility in water of not more than 38 wt % at a temperature of 20° C. (for measurement method, see Examples section). The solubility in water at a temperature of 20° C. is preferably less than 30 wt %. A preferred range is from 1 to 30 wt %.

The solvent (Z.2) accordingly possesses a fairly moderate solubility in water, being in particular not fully miscible with water or possessing no infinite solubility in water. A solvent is fully miscible with water when it can be mixed in any proportions with water without occurrence of separation, in other words of the formation of two phases.

Examples of solvents (Z.2) are methyl ethyl ketone, methyl isobutyl ketone, diisobutyl ketone, diethyl ether, dibutyl ether, dipropylene glycol dimethyl ether, ethylene glycol diethyl ether, toluene, methyl acetate, ethyl acetate, butyl acetate, propylene carbonate, cyclohexanone, or mixtures of these solvents. Preference is given to methyl ethyl ketone, which has a solubility in water of 24 wt % at 20° C.

No solvents (Z.2) are therefore solvents such as acetone, N-methyl-2-pyrrolidone, N-ethyl-2-pyrrolidone, tetrahydrofuran, dioxane, N-formylmorpholine, dimethylformamide, or dimethyl sulfoxide.

A particular effect of selecting the specific solvents (Z.2) with only limited solubility in water is that when the composition (Z) is dispersed in aqueous phase, in step (II) of the process, a homogeneous solution cannot be directly formed. It is assumed that the dispersion that is present instead makes it possible for the crosslinking reactions that occur as part of step (II) (addition reactions of free primary amino groups and isocyanate groups to form urea bonds) to take place in a restricted volume, thereby ultimately allowing the formation of the microparticles defined as above.

As well as having the water solubility described, preferred solvents (Z.2) possess a boiling point of not more than 120° C., more preferably of not more than 90° C. (under atmospheric pressure, in other words 1.013 bar). This has advantages in the context of step (III) of the process, said step being described later on below, in other words the at least partial removal of the at least one organic solvent (Z.2) from the dispersion prepared in step (II) of the process. The reason is evidently that, when using the solvents (Z.2) that are preferred in this context, these solvents can be removed by distillation, for example, without the removal simultaneously of significant quantities of the water introduced in step (II) of the process. There is therefore no need, for example, for the laborious re-addition of water in order to retain the aqueous nature of the dispersion (PD).

The fraction of the at least one organic solvent (Z.2) is from 35 to 85 wt %, preferably from 40 to 75 wt %, more preferably from 45 to 70 wt %, especially preferably from 47.5 to 65 wt %, and, in one very particular embodiment, from 50 to 60 wt %, based in each case on the total amount of the composition (Z).

In the context of the present invention it has emerged that through the specific combination of a fraction as specified above for the intermediate (Z.1) in the composition (Z), and through the selection of the specific solvents (Z.2) it is possible, after the below-described steps (II) and (III), to provide polyurethane-polyurea dispersions which comprise polyurethane-polyurea particles having the requisite particle size, which further have the requisite gel fraction.

The components (Z.1) and (Z.2) described preferably make up in total at least 90 wt % of the composition (Z). Preferably the two components make up at least 95 wt %, more particularly at least 97.5 wt %, of the composition (Z). With very particular preference, the composition (Z) consists of these two components. In this context it should be noted that where neutralizing agents as described above are used, these neutralizing agents are ascribed to the intermediate when calculating the amount of an intermediate (Z.1). The reason is that in this case the intermediate (Z.1) at any rate possesses anionic groups, which originate from the use of the neutralizing agent. Accordingly, the cation that is present after these anionic groups have formed is likewise ascribed to the intermediate.

Where the composition (Z) includes other components, in addition to components (Z.1) and (Z.2), these other components are preferably just organic solvents. The solids content of the composition (Z) therefore corresponds preferably to the fraction of the intermediate (Z.1) in the composition (Z). The composition (Z) therefore possesses preferably a solids content of 15 to 65 wt %, preferably of 25 to 60 wt %, more preferably of 30 to 55 wt %, especially preferably of 35 to 52.5 wt %, and, in one especially preferred embodiment, of 40 to 50 wt %.

A particularly preferred composition (Z) therefore contains in total at least 90 wt % of components (Z.1) and (Z.2), and other than the intermediate (Z.1) includes exclusively organic solvents.

An advantage of the composition (Z) is that it can be prepared without the use of eco-unfriendly and health-injurious organic solvents such as N-methyl-2-pyrrolidone, dimethylformamide, dioxane, tetrahydrofuran, and N-ethyl-2-pyrrolidone. Preferably, accordingly, the composition (Z) contains less than 10 wt %, preferably less than 5 wt %, more preferably less than 2.5 wt % of organic solvents selected from the group consisting of N-methyl-2-pyrrolidone, dimethylformamide, dioxane, tetrahydrofuran, and N-ethyl-2-pyrrolidone. The composition (Z) is preferably entirely free from these organic solvents.

In a second step (II) of the process described here, the composition (Z) is dispersed in aqueous phase.

It is known, and also follows from what has already been said above, that in step (II), therefore, there is a deblocking of the blocked primary amino groups of the intermediate (Z.1). Indeed, as a result of the transfer of a blocked amine to the aqueous phase, the reversibly attached blocking agent is released, with consumption of water, and free primary amino groups are formed.

It is likewise clear, therefore, that the resulting free primary amino groups are then reacted with isocyanate groups likewise present in the intermediate (Z.1), or in the deblocked intermediate formed from the intermediate (Z.1), by addition reaction, with formation of urea bonds.

It is also known that the transfer to the aqueous phase means that it is possible in principle for isocyanate groups in the intermediate (Z.1), or in the deblocked intermediate formed from the intermediate (Z.1), to react with the water, with elimination of carbon dioxide, to form free primary amino groups, which can then be reacted in turn with isocyanate groups still present.

Of course, the reactions and conversions referred to above proceed in parallel with one another. Ultimately, as a result, for example, of intermolecular and intramolecular reaction or crosslinking, a dispersion is formed which comprises polyurethane-polyurea particles with defined average particle size and with defined degree of crosslinking or gel fraction.

In step (II) of the process described here, the composition (Z) is dispersed in water, there being a deblocking of the blocked primary amino groups of the intermediate (Z.1) and a reaction of the resulting free primary amino groups with the isocyanate groups of the intermediate (Z.1) and also with the isocyanate groups of the deblocked intermediate formed from the intermediate (Z.1), by addition reaction.

Step (II) of the process of the invention, in other words the dispersing in aqueous phase, may take place in any desired way. This means that ultimately the only important thing is that the composition (Z) is mixed with water or with an aqueous phase. With preference, the composition (Z), which after the preparation may be for example at room temperature, in other words 20 to 25° C., or at a temperature increased relative to room temperature, of 30 to 60° C., for example, can be stirred into water, producing a dispersion. The water already introduced has room temperature, for example. Dispersion may take place in pure water (deionized water), meaning that the aqueous phase consists solely of water, this being preferred. Besides water, of course, the aqueous phase may also include, proportionally, typical auxiliaries such as typical emulsifiers and protective colloids. A compilation of suitable emulsifiers and protective colloids is found in, for example, Houben Weyl, Methoden der organischen Chemie [Methods of Organic Chemistry], volume XIV/1 Makromolekulare Stoffe [Macromolecular compounds], Georg Thieme Verlag, Stuttgart 1961, p. 411 ff.

It is of advantage if in stage (II) of the process, in other words at the dispersing of the composition (Z) in aqueous phase, the weight ratio of organic solvents and water is selected such that the resulting dispersion has a weight ratio of water to organic solvents of greater than 1, preferably of 1.05 to 2/1, especially preferably of 1.1 to 1.5/1.

In step (III) of the process described here, the at least one organic solvent (Z.2) is removed at least partly from the dispersion obtained in step (II). Of course, step (III) of the process may also entail removal of other solvents as well, possibly present, for example, in the composition (Z).

The removal of the at least one organic solvent (Z.2) and of any further organic solvents may be accomplished in any way which is known, as for example by vacuum distillation at temperatures slightly raised relative to room temperature, of 30 to 60° C., for example.

The resulting polyurethane-polyurea dispersion (PD) is aqueous (regarding the basic definition of “aqueous”, see earlier on above).

A particular advantage of the dispersion (PD) in accordance with the invention is that it can be formulated with only very small fractions of organic solvents, yet enables the advantages described at the outset in accordance with the invention. The dispersion (PD) in accordance with the invention contains preferably less than 7.5 wt %, especially preferably less than 5 wt %, very preferably less than 2.5 wt % of organic solvents (for measurement method, see Examples section).

The fraction of the polyurethane-polyurea polymer in the dispersion (PD) is preferably 25 to 55 wt %, preferably 30 to 50 wt %, more preferably 35 to 45 wt %, based in each case on the total amount of the dispersion (determined as for the determination described above for the intermediate (Z.1) via the solids content).

The fraction of water in the dispersion (PD) is preferably 45 to 75 wt %, preferably 50 to 70 wt %, more preferably 55 to 65 wt %, based in each case on the total amount of the dispersion.

It is preferred if the dispersion (PD) of the invention consists to an extent of at least 90 wt %, preferably at least 92.5 wt %, very preferably at least 95 wt %, and even more preferably at least 97.5 wt % of the polyurethane-polyurea particles and water (the associated value is obtained by summing the amount of the particles (that is, of the polymer, determined via the solids content) and the amount of water). It has emerged that in spite of this low fraction of further components such as organic solvents in particular, the dispersions of the invention are in any case very stable, more particularly storage-stable. In this way, two relevant advantages are united. First, dispersions are provided which can be used in aqueous basecoat materials, where they lead to the performance advantages described at the outset and also in the examples hereinafter. Secondly, however, a commensurate freedom in formulation is achieved for the preparation of aqueous basecoat materials. This means that additional fractions of organic solvents can be used in the basecoat materials, being necessary, for example, in order to provide appropriate formulation of different components. But at the same time the fundamentally aqueous nature of the basecoat material is not jeopardized. On the contrary: the basecoat materials can nevertheless be formulated with comparatively low fractions of organic solvents, and therefore have a particularly good environmental profile.

Even more preferred is for the dispersion, other than the polymer, to include only water and any organic solvents, in the form, for example, of residual fractions, not fully removed in stage (III) of the process. The solids content of the dispersion (PD) is therefore preferably 25% to 55%, preferably 30% to 50%, more preferably 35% to 45%, and more preferably still is in agreement with the fraction of the polymer in the dispersion.

An advantage of the dispersion (PD) is that it can be prepared without the use of eco-unfriendly and health-injurious organic solvents such as N-methyl-2-pyrrolidone, dimethylformamide, dioxane, tetrahydrofuran, and N-ethyl-2-pyrrolidone. Accordingly the dispersion (PD) contains preferably less than 7.5 wt %, preferably less than 5 wt %, more preferably less than 2.5 wt % of organic solvents selected from the group consisting of N-methyl-2-pyrrolidone, dimethylformamide, dioxane, tetrahydrofuran, and N-ethyl-2-pyrrolidone. The dispersion (PD) is preferably entirely free from these organic solvents.

The acid number of the polyurethane-polyurea polymer present in the dispersion, based on the solids content, is preferably from 10 from 35 mg KOH/g, more particularly from 15 to 23 mg KOH/g (for measurement method see Example section).

The polyurethane-polyurea polymer present in the dispersion preferably possesses hardly any hydroxyl groups, or none. The OH number of the polymer, based on the solids content, is preferably less than 15 mg KOH/g, more particularly less than 10 mg KOH/g, more preferably still less than 5 mg KOH/g (for measurement method, see Examples section).

The fraction of the one or more dispersions (PD), based on the total weight of the aqueous basecoat material of the invention, is preferably 1.0 to 60 wt %, more preferably 2.5 to 50 wt %, and very preferably 5 to 40 wt %.

The fraction of the polymers originating from the dispersions (PD), based on the total weight of the aqueous basecoat material of the invention, is preferably from 0.4 to 24.0 wt %, more preferably 1.0 to 20.0 wt %, and very preferably 2.0 to 16.0 wt %.

Determining or specifying the fraction of the polymers originating from the dispersions (PD) for inventive use in the basecoat material may be done via the determination of the solids content (also called nonvolatile fraction or solids fraction) of a dispersion (PD) which is to be used in the basecoat material. The same goes for the fractions of other components, in a dispersion (wD), for example.

The basecoat material of the invention comprises at least one, preferably precisely one, specific aqueous dispersion (wD) which comprises a specific polymer.

The preparation of the polymer encompasses the successive radical emulsion polymerization of three different mixtures (A), (B), and (C), of olefinically unsaturated monomers. The process is therefore a multistage radical emulsion polymerization, in which i. first of all the mixture (A) is polymerized, then ii. the mixture (B) is polymerized in the presence of the polymer prepared under i., and additionally iii. the mixture (C) is polymerized in the presence of the polymer prepared under ii. All three monomer mixtures are therefore polymerized via a radical emulsion polymerization conducted separately in each case (that is, a stage, or else polymerization stage), with these stages taking place in succession. In terms of time, the stages may take place directly one after another. It is equally possible for the corresponding reaction solution after the end of one stage to be stored for a certain time and/or transferred to a different reaction vessel, and only then for the next stage to take place. The preparation of the specific multistage polymer preferably comprises no further polymerization steps additional to the polymerization of the monomer mixtures (A), (B), and (C).

The concept of radical emulsion polymerization is familiar to the skilled person and is elucidated in greater precision again below, moreover.

In a polymerization of this kind, olefinically unsaturated monomers are polymerized in an aqueous medium, using at least one water-soluble initiator, and in the presence of at least one emulsifier.

Corresponding water-soluble initiators are likewise known. The at least one water-soluble initiator is preferably selected from the group consisting of potassium, sodium, or ammonium peroxodisulfate, hydrogen peroxide, tert-butyl hydroperoxide, 2,2′-azo-bis(2-amidoisopropane) dihydrochloride, 2,2′-azobis(N,N′-dimethyleneisobutyramidine) dihydrochloride, 2,2′-azobis(4-cyanopentanoic acid), and mixtures of the aforementioned initiators, such as hydrogen peroxide and sodium persulfate, for example. Likewise members of the stated preferred group are the redox initiator systems that are known per se.

By redox initiator systems are meant in particular those initiators which comprise at least one peroxide-containing compound in combination with at least one redox coinitiator, examples being reductive sulfur compounds such as, for example, bisulfites, sulfites, thiosulfates, dithionites or tetrathionates of alkali metals and ammonium compounds, sodium hydroxymethanesulfinate dihydrate and/or thiourea. Accordingly it is possible to use combinations of peroxodisulfates with alkali metal or ammonium hydrogensulfites, examples being ammonium peroxodisulfate and ammonium disulfite. The weight ratio of peroxide-containing compounds to the redox coinitiators is preferably 50:1 to 0.05:1.

In combination with the initiators it is possible additionally to use transition metal catalysts, such as salts of iron, nickel, cobalt, manganese, copper, vanadium, or chromium, for example, such as iron(II) sulfate, cobalt(II) chloride, nickel(II) sulfate, copper(I) chloride, manganese(II) acetate, vanadium(III) acetate, manganese(II) chloride. Based on the total mass of the olefinically unsaturated monomers used in a polymerization, these transition metal salts are employed customarily in amounts of 0.1 to 1000 ppm. Hence it is possible to use combinations of hydrogen peroxide with iron(II) salts, such as, for example, 0.5 to 30 wt % of hydrogen peroxide and 0.1 to 500 ppm of Mohr's salt, in which case the fractional ranges are based in each case on the total weight of the monomers used in the respective polymerization stage.

The initiators are used preferably in an amount of 0.05 to 20 wt %, preferably 0.05 to 10, more preferably from 0.1 to 5 wt %, based on the total weight of the monomers used in the respective polymerization stage.

An emulsion polymerization takes place within a reaction medium that comprises water as continuous medium and comprises the at least one emulsifier in the form of micelles. The polymerization is initiated by decomposition of the water-soluble initiator in the water. The growing polymer chain enters the emulsifier micelles, and the further polymerization then takes place in the micelles. In addition to the monomers, the at least one water-soluble initiator, and the at least one emulsifier, the reaction mixture therefore consists primarily of water. The stated components, namely monomers, water-soluble initiator, emulsifier, and water, preferably account for at least 95 wt % of the reaction mixture. The reaction mixture preferably consists of these components.

It is therefore evidently possible for at least one emulsifier to be added at each individual polymerization step. Equally possible, however, is the addition of at least one emulsifier only in one (in the first) or two polymerization stage(s) (in the first and in a further stage). The amount of emulsifier in that case is selected such that there is a sufficient amount of emulsifier present even for stages where no separate addition takes place.

Emulsifiers as well are known in principle. Use may be made of nonionic or ionic emulsifiers, including zwitterionic emulsifiers, and also, optionally, mixtures of the aforementioned emulsifiers.

Preferred emulsifiers are optionally ethoxylated and/or propoxylated alkanols having 10 to 40 carbon atoms. They may have different degrees of ethoxylation and/or propoxylation (for example, adducts modified with poly(oxy)ethylene and/or poly(oxy)propylene chains consisting of 5 to 50 molecule units). Also possible for use are sulfated, sulfonated, or phosphated derivatives of the stated products. Such derivatives are generally employed in neutralized form.

Particularly preferred emulsifiers suitable are neutralized dialkylsulfosuccinic esters or alkyldiphenyl oxide disulfonates, available commercially for example as EF-800 from Cytec.

The emulsion polymerizations are carried out usefully at a temperature of 0 to 160° C., preferably of 15 to 95° C., more preferably of 60 to 95° C.

It is preferred here to operate in the absence of oxygen, and preferably under an inert gas atmosphere. The polymerization is generally carried out under atmospheric pressure, although the application of lower pressures or higher pressures is also possible. Particularly if polymerization temperatures are employed which lie above the boiling point under atmospheric pressure of water, of the monomers used and/or of the organic solvents, it is usual to select higher pressures.

The individual polymerization stages in the preparation of the specific polymer may be carried out, for example, as what are called “starved feed” polymerizations (also known as “starve feed” or “starve fed” polymerizations).

A starved feed polymerization in the sense of the present invention is an emulsion polymerization in which the amount of free olefinically unsaturated monomers in the reaction solution (also called reaction mixture) is minimized throughout the reaction time. This means that the metered addition of the olefinically unsaturated monomers is such that over the entire reaction time a fraction of free monomers in the reaction solution does not exceed 6.0 wt %, preferably 5.0 wt %, more preferably 4.0 wt %, particularly advantageously 3.5 wt %, based in each case on the total amount of the monomers used in the respective polymerization stage. Further preferred within these structures are concentration ranges for the olefinically unsaturated monomers of 0.01 to 6.0 wt %, preferably 0.02 to 5.0 wt %, more preferably 0.03 to 4.0 wt %, more particularly 0.05 to 3.5 wt %. For example, the highest weight fraction detectable during the reaction may be 0.5 wt %, 1.0 wt %, 1.5 wt %, 2.0 wt %, 2.5 wt %, or 3.0 wt %, while all other values detected then lie below the values indicated here. The total amount (also called total weight) of the monomers used in the respective polymerization stage evidently corresponds for stage i. to the total amount of the monomer mixture (A), for stage ii. to the total amount of the monomer mixture (B), and for stage iii. to the total amount of the monomer mixture (C).

The concentration of the monomers in the reaction solution here may be determined by gas chromatography, for example. In that case a sample of the reaction solution is cooled with liquid nitrogen immediately after sampling, and 4-methoxyphenol is added as an inhibitor. In the next step, the sample is dissolved in tetrahydrofuran and then n-pentane is added in order to precipitate the polymer formed at the time of sampling. The liquid phase (supernatant) is then analyzed by gas chromatography, using a polar column and an apolar column for determining the monomers, and a flame ionization detector. Typical parameters for the gas-chromatographic determination are as follows: 25 m silica capillary column with 5% phenyl-, 1% vinyl-methylpolysiloxane phase, or 30 m silica capillary column with 50% phenyl-, 50% methyl-polysiloxane phase, carrier gas hydrogen, split injector 150° C., oven temperature 50 to 180° C., flame ionization detector, detector temperature 275° C., internal standard isobutyl acrylate. The concentration of the monomers is determined, for the purposes of the present invention, preferably by gas chromatography, more particularly in compliance with the parameters specified above.

The fraction of the free monomers can be controlled in various ways.

One possibility for keeping the fraction of the free monomers low is to select a very low metering rate for the mixture of the olefinically unsaturated monomers into the actual reaction solution, wherein the monomers make contact with the initiator. If the metering rate is so low that all of the monomers are able to react virtually immediately when they are in the reaction solution, it is possible to ensure that the fraction of the free monomers is minimized.

In addition to the metering rate it is important that there are always sufficient radicals present in the reaction solution to allow each of the added monomers to react extremely quickly. In this way, further chain growth of the polymer is guaranteed and the fraction of free monomer is kept low.

For this purpose, the reaction conditions are preferably selected such that the initiator feed is commenced even before the start of the metering of the olefinically unsaturated monomers. The metering is preferably commenced at least 5 minutes beforehand, more preferably at least 10 minutes beforehand. With preference at least 10 wt % of the initiator, more preferably at least 20 wt %, very preferably at least 30 wt % of the initiator, based in each case on the total amount of initiator, is added before the metering of the olefinically unsaturated monomers is commenced.

Preference is given to selecting a temperature which allows constant decomposition of the initiator.

The amount of initiator is likewise an important factor for the sufficient presence of radicals in the reaction solution. The amount of initiator should be selected such that at any given time there are sufficient radicals available, allowing the added monomers to react. If the amount of initiator is increased, it is also possible to react greater amounts of monomers at the same time.

A further factor determining the reaction rate is the reactivity of the monomers.

Control over the fraction of the free monomers can therefore be guided by the interplay of initiator quantity, rate of initiator addition, rate of monomer addition, and through the selection of the monomers. Not only a slowing-down of metering but also an increase in the initial quantity, and also the premature commencement of addition of the initiator, serve the aim of keeping the concentration of free monomers below the limits stated above.

At any point during the reaction, the concentration of the free monomers can be determined by gas chromatography, as described above.

Should this analysis find a concentration of free monomers that comes close to the limiting value for the starved feed polymerization, as a result, for example, of small fractions of highly reactive olefinically unsaturated monomers, the parameters referred to above can be utilized in order to control the reaction. In this case, for example, the metering rate of the monomers can be reduced, or the amount of initiator can be increased.

For the purposes of the present invention it is preferable for the polymerization stages ii. and iii. to be carried out under starved feed conditions. This has the advantage that the formation of new particle nuclei within these two polymerization stages is effectively minimized. Instead, the particles existing after stage i. (and therefore also called seed below) can be grown further in stage ii. by the polymerization of the monomer mixture B (therefore also called core below). It is likewise possible for the particles existing after stage ii. (also below called polymer comprising seed and core) to be grown further in stage iii. through the polymerization of the monomer mixture C (therefore also called shell below), resulting ultimately in a polymer comprising particles containing seed, core, and shell.

The mixtures (A), (B), and (C) are mixtures of olefinically unsaturated monomers. Suitable olefinically unsaturated monomers may be mono- or polyolefinically unsaturated.

Described first of all below are monomers which can be used in principle and which are suitable across all mixtures (A), (B), and (C), and monomers that are optionally preferred. Specific preferred embodiments of the individual mixtures are addressed thereafter.

Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example. The term (meth)acrylic or (meth)acrylate for the purposes of the present invention encompasses both methacrylates and acrylates. Preferred for use at any rate, although not necessarily exclusively, are (meth)acrylate-based monoolefinically unsaturated monomers.

The (meth)acrylate-based monoolefinically unsaturated monomers may be, for example, (meth)acrylic acid and esters, nitriles, or amides of (meth)acrylic acid.

Preference is given to esters of (meth)acrylic acid having a non-olefinically unsaturated radical R

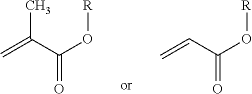

The radical R may be saturated aliphatic, aromatic, or mixed saturated aliphatic-aromatic. Aliphatic radicals for the purposes of the present invention are all organic radicals which are not aromatic. Preferably the radical R is aliphatic.

The saturated aliphatic radical may be a pure hydrocarbon radical or it may include heteroatoms from bridging groups (for example, oxygen from ether groups or ester groups) and/or may be substituted by functional groups containing heteroatoms (alcohol groups, for example). For the purposes of the present invention, therefore, a clear distinction is made between bridging groups containing heteroatoms and functional groups containing heteroatoms (that is, terminal functional groups containing heteroatoms).

Preference is given at any rate, though not necessarily exclusively, to using monomers in which the saturated aliphatic radical R is a pure hydrocarbon radical (alkyl radical), in other words one which does not include any heteroatoms from bridging groups (oxygen from ether groups, for example) and is also not substituted by functional groups (alcohol groups, for example).

If R is an alkyl radical, it may for example be a linear, branched, or cyclic alkyl radical. Such an alkyl radical may of course also have linear and cyclic or branched and cyclic structural components. The alkyl radical preferably has 1 to 20, more preferably 1 to 10, carbon atoms.

Particularly preferred monounsaturated esters of (meth)acrylic acid with an alkyl radical are methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, ethylhexyl (meth)acrylate, 3,3,5-trimethylhexyl (meth)acrylate, stearyl (meth)acrylate, lauryl (meth)acrylate, cycloalkyl (meth)acrylates, such as cyclopentyl (meth)acrylate, isobornyl (meth)acrylate, and also cyclohexyl (meth)acrylate, with very particular preference being given to n- and tert-butyl (meth)acrylate and to methyl methacrylate.

Examples of other suitable radicals R are saturated aliphatic radicals which comprise functional groups containing heteroatoms (for example, alcohol groups or phosphoric ester groups).

Suitable monounsaturated esters of (meth)acrylic acid with a saturated aliphatic radical substituted by one or more hydroxyl groups are 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate, with very particular preference being given to 2-hydroxyethyl (meth)acrylate.

Suitable monounsaturated esters of (meth)acrylic acid with phosphoric ester groups are, for example, phosphoric esters of polypropylene glycol monomethacrylate, such as the commercially available Sipomer PAM 200 from Rhodia.

Possible further monoolefinically unsaturated monomers containing vinyl groups are monomers which are different from the above-described acrylate-based monomers and which have a radical R′ on the vinyl group that is not olefinically unsaturated.

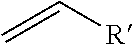

The radical R′ may be saturated aliphatic, aromatic, or mixed saturated aliphatic-aromatic, with preference being given to aromatic and mixed saturated aliphatic-aromatic radicals in which the aliphatic components represent alkyl groups.

Particularly preferred further monoolefinically unsaturated monomers containing vinyl groups are, in particular, vinyltoluene, alpha-methylstyrene, and especially styrene.

Also possible are monounsaturated monomers containing vinyl groups wherein the radical R′ has the following structure:

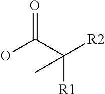

where the radicals R1 and R2 as alkyl radicals contain a total of 7 carbon atoms. Monomers of this kind are available commercially under the name VeoVa 10 from Momentive.

Further monomers suitable in principle are olefinically unsaturated monomers such as acrylonitrile, methacrylonitrile, acrylamide, methacrylamide, N,N-dimethylacrylamide, vinyl acetate, vinyl propionate, vinyl chloride, N-vinylpyrrolidone, N-vinylcaprolactam, N-vinylformamide, N-vinylimidazole, N-vinyl-2-methylimidazoline, and further unsaturated alpha-beta-carboxylic acids.

Examples of suitable polyolefinically unsaturated monomers include esters of (meth)acrylic acid with an olefinically unsaturated radical R″. The radical R″ may be, for example, an allyl radical or a (meth)acryloyl radical.

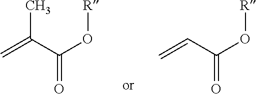

Preferred polyolefinically unsaturated monomers include ethylene glycol di(meth)acrylate, 1,2-propylene glycol di(meth)acrylate, 2,2-propylene glycol di(meth)-acrylate, butane-1,4-diol di(meth)acrylate, neopentyl glycol di(meth)acrylate, 3-methylpentanediol di(meth)acrylate, diethylene glycol di(meth)acrylate, triethylene glycol di(meth)acrylate, tetraethylene glycol di(meth)acrylate, dipropylene glycol di(meth)acrylate, tripropylene glycol di(meth)acrylate, hexanediol di(meth)acrylate, and allyl (meth)acrylate.

Furthermore, preferred polyolefinically unsaturated compounds encompass acrylic and methacrylic esters of alcohols having more than two OH groups, such as, for example, trimethylolpropane tri(meth)acrylate or glycerol tri(meth)acrylate, but also trimethylolpropane di(meth)acrylate monoallyl ether, trimethylolpropane (meth)acrylate diallyl ether, pentaerythritol tri(meth)acrylate monoallyl ether, pentaerythritol di(meth)acrylate diallyl ether, pentaerythritol (meth)acrylate triallyl ether, triallylsucrose, and pentaallylsucrose.

Also possible are allyl ethers of mono- or polyhydric alcohols, such as trimethylolpropane monoallyl ether, for example.

Where used, which is preferred, preferred polyolefinically unsaturated monomers are hexanediol diacrylate and/or allyl (meth)acrylate.

With regard to the monomer mixtures (A), (B), and (C) used in the individual polymerization stages, there are specific conditions to be observed, which are set out below.

First of all it should be stated that the mixtures (A), (B), and (C) are at any rate different from one another. They therefore each contain different monomers and/or different proportions of at least one defined monomer.

Mixture (A) comprises, preferably but not necessarily, at least 50 wt %, more preferably at least 55 wt %, of olefinically unsaturated monomers having a water solubility of less than 0.5 g/l at 25° C. One such preferred monomer is styrene.

The solubility of the monomers in water can be determined via establishment of equilibrium with the gas space above the aqueous phase (in analogy to the reference X.-S. Chai, Q. X. Hou, F. J. Schork, Journal of Applied Polymer Science Vol. 99, 1296-1301 (2006)).

For this purpose, in a 20 ml gas space sample tube, to a defined volume of water, preferably 2 ml, a mass of the respective monomer is added which is of a magnitude such that this mass can at any rate not be dissolved completely in the selected volume of water. Additionally an emulsifier is added (10 ppm, based on total mass of the sample mixture). In order to obtain the equilibrium concentration, the mixture is shaken continually. The supernatant gas phase is replaced by inert gas, and so an equilibrium is established again. In the gas phase withdrawn, the fraction of the substance to be detected is measured (preferably by gas chromatography). The equilibrium concentration in water can be determined by plotting the fraction of the monomer in the gas phase. The slope of the curve changes from a virtually constant value (S1) to a significantly negative slope (S2) as soon as the excess monomer fraction has been removed from the mixture. The equilibrium concentration here is reached at the point of intersection of the straight line with the slope S1 and of the straight line with the slope S2. The determination described is carried out at 25° C.

The monomer mixture (A) preferably contains no hydroxy-functional monomers. Likewise preferably, the monomer mixture (A) contains no acid-functional monomers.

Very preferably the monomer mixture (A) contains no monomers at all that have functional groups containing heteroatoms. This means that heteroatoms, if present, are present only in the form of bridging groups. This is the case, for example, in the monoolefinically unsaturated monomers described above that are (meth)acrylate-based and possess an alkyl radical as radical R.

The monomer mixture (A) preferably comprises exclusively monoolefinically unsaturated monomers.

In one particularly preferred embodiment, the monomer mixture (A) comprises at least one monounsaturated ester of (meth)acrylic acid with an alkyl radical and at least one monoolefinically unsaturated monomer containing vinyl groups, with a radical arranged on the vinyl group that is aromatic or that is mixed saturated aliphatic-aromatic, in which case the aliphatic fractions of the radical are alkyl groups.

The monomers present in the mixture (A) are selected such that a polymer prepared from them possesses a glass transition temperature of 10 to 65° C., preferably of 30 to 50° C.

The glass transition temperature T_{g} for the purposes of the invention is determined experimentally on the basis of DIN 51005 “Thermal Analysis (TA)—terms” and DIN 53765 “Thermal Analysis—Dynamic Scanning calorimetry (DSC)”. This involves weighing out a 15 mg sample into a sample boat and introducing it into a DSC instrument. After cooling to the start temperature, 1st and 2nd measurement runs are carried out with inert gas flushing (N₂) of 50 ml/min with a heating rate of 10 K/min, with cooling to the start temperature again between the measurement runs. Measurement takes place customarily in the temperature range from about 50° C. lower than the expected glass transition temperature to about 50° C. higher than the glass transition temperature. The glass transition temperature for the purposes of the present invention, in accordance with DIN 53765, section 8.1, is that temperature in the 2nd measurement run at which half of the change in the specific heat capacity (0.5 delta cₚ) is reached. This temperature is determined from the DSC diagram (plot of the heat flow against the temperature). It is the temperature at the point of intersection of the midline between the extrapolated baselines, before and after the glass transition, with the measurement plot.

Where reference is made in the context of the present invention to an official standard without any indication of the official validity period, the reference is of course to that version of the standard that is valid on the filing date or, if there is no valid version at that point in the time, to the last valid version.

For a useful estimation of the glass transition temperature to be expected in the measurement, the known Fox equation can be employed. Since the Fox equation represents a good approximation, based on the glass transition temperatures of the homopolymers and their parts by weight, without incorporation of the molecular weight, it can be used as a guide to the skilled person in the synthesis, allowing a desired glass transition temperature to be set via a few goal-directed experiments.

The polymer prepared in stage i. by the emulsion polymerization of the monomer mixture (A) is also called seed.

The seed possesses preferably a particle size of 20 to 125 nm (for measurement method see Examples section).

Mixture (B) preferably comprises at least one polyolefinically unsaturated monomer, more preferably at least one diolefinically unsaturated monomer. One such preferred monomer is hexanediol diacrylate.

The monomer mixture (B) preferably contains no hydroxy-functional monomers. Likewise preferably, the monomer mixture (B) contains no acid-functional monomers.

Very preferably the monomer mixture (B) contains no monomers at all with functional groups containing heteroatoms. This means that heteroatoms, if present, are present only in the form of bridging groups. This is the case, for example, in the above-described monoolefinically unsaturated monomers which are (meth)acrylate-based and possess an alkyl radical as radical R.

In one particularly preferred embodiment, the monomer mixture (B), as well as the at least one polyolefinically unsaturated monomer, includes at any rate the following further monomers. First of all, at least one monounsaturated ester of (meth)acrylic acid with an alkyl radical, and secondly at least one monoolefinically unsaturated monomer containing vinyl groups and having a radical located on the vinyl group that is aromatic or that is a mixed saturated aliphatic-aromatic radical, in which case the aliphatic fractions of the radical are alkyl groups.

The fraction of polyunsaturated monomers is preferably from 0.05 to 3 mol %, based on the total molar amount of monomers in the monomer mixture (B).

The monomers present in the mixture (B) are selected such that a polymer prepared therefrom possesses a glass transition temperature of −35 to 15° C., preferably of −25 to +7° C.

The polymer prepared in the presence of the seed in stage ii. by the emulsion polymerization of the monomer mixture (B) is also referred to as the core. After stage ii., then, the result is a polymer which comprises seed and core.

The polymer which is obtained after stage ii. preferably possesses a particle size of 80 to 280 nm, preferably 120 to 250 nm.

The monomers present in the mixture (C) are selected such that a polymer prepared therefrom possesses a glass transition temperature of −50 to 15° C., preferably of −20 to +12° C.

The olefinically unsaturated monomers of this mixture (C) are preferably selected such that the resulting polymer, comprising seed, core, and shell, has an acid number of 10 to 25.

Accordingly, the mixture (C) preferably comprises at least one alpha-beta unsaturated carboxylic acid, especially preferably (meth)acrylic acid.

The olefinically unsaturated monomers of the mixture (C) are further preferably selected such that the resulting polymer, comprising seed, core, and shell, has an OH number of 0 to 30, preferably 10 to 25.

All of the aforementioned acid numbers and OH numbers in connection with the dispersion (wD) are values calculated on the basis of the monomer mixtures employed overall.

In one particularly preferred embodiment, the monomer mixture (C) comprises at least one alpha-beta unsaturated carboxylic acid and at least one monounsaturated ester of (meth)acrylic acid having an alkyl radical substituted by a hydroxyl group.

In one especially preferred embodiment, the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid having an alkyl radical.

Where reference is made, in the context of the present invention, to an alkyl radical, without further particularization, what is always meant by this is a pure alkyl radical without functional groups and heteroatoms.

The polymer prepared in the presence of seed and core in stage iii. by the emulsion polymerization of the monomer mixture (C) is also referred to as the shell. The result after stage iii., then, is a polymer which comprises seed, core, and shell.

Following its preparation, the polymer possesses a particle size of 100 to 500 nm, preferably 125 to 400 nm, very preferably from 130 to 300 nm.

The fractions of the monomer mixtures are preferably harmonized with one another as follows. The fraction of the mixture (A) is from 0.1 to 10 wt %, the fraction of the mixture (B) is from 60 to 80 wt %, and the fraction of the mixture (C) is from 10 to 30 wt %, based in each case on the sum of the individual amounts of the mixtures (A), (B), and (C).

The aqueous dispersion (wD) preferably possesses a pH of 5.0 to 9.0, more preferably 7.0 to 8.5, very preferably 7.5 to 8.5. The pH may be kept constant during the preparation itself, through the use of bases as identified further on below, for example, or else may be set deliberately after the polymer has been prepared.

In especially preferred embodiments it is the case that the aqueous dispersion (wD) has a pH of 5.0 to 9.0 and the at least one polymer present therein has a particle size of 100 to 500 nm. Even more preferred range combinations are as follows: pH of 7.0 to 8.5 and a particle size of 125 to 400 nm, more preferably pH of 7.5 to 8.5 and a particle size of 130 to 300 nm.

The stages i. to iii. described are carried out preferably without addition of acids or bases known for the setting of the pH. If in the preparation of the polymer, for example, carboxy-functional monomers are then used, as is preferred in the context of stage iii., the pH of the dispersion may be less than 7 after the end of stage iii. Accordingly, an addition of base is needed in order to adjust the pH to a higher value, such as, for example, a value within the preferred ranges.

It follows from the above that the pH preferably after stage iii. is correspondingly adjusted or has to be adjusted, in particular through addition of a base such as an organic, nitrogen-containing base, such as an amine such as ammonia, trimethylamine, triethylamine, tributylamines, dimethylaniline, triphenylamine, N,N-dimethylethanolamine, methyldiethanolamine, or triethanolamine, and also by addition of sodium hydrogencarbonate or borates, and also mixtures of the aforesaid substances. This, however, does not rule out the possibility of adjusting the pH before, during, or after the emulsion polymerizations or else between the individual emulsion polymerizations. It is likewise possible for there to be no need at all for the pH to be adjusted to a desired value, owing to the choice of the monomers.

The measurement of the pH here is carried out preferably using a pH meter (for example, Mettler-Toledo S20 SevenEasy pH meter) having a combined pH electrode (for example, Mettler-Toledo InLab® Routine).

The solids content of the dispersion (wD) is preferably from 15% to 40% and more preferably 20% to 30%.

The dispersion (wD) is aqueous (see above for the fundamental definition). It is preferably the case for the aqueous dispersion (wD) that it comprises a fraction of 55 to 75 wt %, especially preferably 60 to 70 wt %, based in each case on the total weight of the dispersion, of water.

It is further preferred for the percentage sum of the solids content of the dispersion (wD) and the fraction of water in the dispersion (wD) to be at least 80 wt %, preferably at least 90 wt %. Preferred in turn are ranges from 80 to 99 wt %, especially 90 to 97.5 wt %. In this figure, the solids content, which traditionally only possesses the unit “%”, is reported in “wt %”. Since the solids content ultimately also represents a percentage weight figure, this form of representation is justified. Where, for example, a dispersion has a solids content of 25% and a water content of 70 wt %, the above-defined percentage sum of the solids content and the fraction of water amounts to 95 wt %, therefore.

The dispersion accordingly consists very largely of water and of the specific polymer, and environmentally burdensome components, such as organic solvents in particular, are present only in minor proportions or not at all.

The fraction of the one or more dispersions (wD), based on the total weight of the aqueous basecoat material of the invention, is preferably 1.0 to 60 wt %, more preferably 2.5 to 50 wt %, and very preferably 5 to 40 wt %.

The fraction of the polymers originating from the dispersions (wD), based on the total weight of the aqueous basecoat material of the invention, is preferably from 0.3 to 17.0 wt %, more preferably 0.7 to 14.0 wt %, very preferably 1.4 to 11.0 wt %.

For the purposes of the present invention, the principle to be observed for the components for use in the basecoat material—for example, the components of a dispersion (PD), of a dispersion (wD), or else of a melamine resin—is as follows (described here for a dispersion (wD)): In the case of a possible particularization to basecoat materials comprising preferred dispersions (wD) in a specific proportional range, the following applies. The dispersions (wD) which do not fall within the preferred group may of course still be present in the basecoat material. In that case the specific proportional range applies only to the preferred group of dispersions (wD). It is preferred nonetheless for the total proportion of dispersions (wD), consisting of dispersions from the preferred group and dispersions which are not part of the preferred group, to be subject likewise to the specific proportional range.

In the case of a restriction to a proportional range of 2.5 to 50 wt % and to a preferred group of dispersions (wD), therefore, this proportional range evidently applies initially only to the preferred group of dispersions (wD). In that case, however, it would be preferable for there to be likewise from 2.5 to 50 wt % in total present of all originally encompassed dispersions, consisting of dispersions from the preferred group and dispersions which do not form part of the preferred group. If, therefore, 35 wt % of dispersions (wD) of the preferred group are used, not more than 15 wt % of the dispersions of the non-preferred group may be used.

The basecoat material of the invention preferably comprises at least one pigment. Reference here is to conventional pigments imparting color and/or optical effect.

Such color pigments and effect pigments are known to those skilled person and are described, for example, in Römpp-Lexikon Lacke and Druckfarben, Georg Thieme Verlag, Stuttgart, New York, 1998, pages 176 and 451. The terms “coloring pigment” and “color pigment” are interchangeable, just like the terms “optical effect pigment” and “effect pigment”.

Preferred effect pigments are, for example, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as lamellar graphite, lamellar iron oxide, multilayer effect pigments composed of PVD films and/or liquid crystal polymer pigments. Particularly preferred are platelet-shaped metal effect pigments, more particularly lamellar aluminum pigments.

Typical color pigments especially include inorganic coloring pigments such as white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

The fraction of the pigments is preferably situated in the range from 1.0 to 40.0 wt %, preferably 2.0 to 35.0 wt %, more preferably 5.0 to 30.0 wt %, based on the total weight of the aqueous basecoat material in each case.

The aqueous basecoat material preferably further comprises at least one polymer as binder that is different from the polymers present in the dispersions (wD) and (PD), more particularly at least one polymer selected from the group consisting of polyurethanes, polyesters, polyacrylates and/or copolymers of the stated polymers, more particularly polyester and/or polyurethane polyacrylates. Preferred polyesters are described, for example, in DE 4009858 A1 in column 6, line 53 to column 7, line 61 and column 10, line 24 to column 13, line 3, or WO 2014/033135 A2, page 2, line 24 to page 7, line 10 and page 28, line 13 to page 29, line 13. Preferred polyurethane-polyacrylate copolymers (acrylated polyurethanes) and their preparation are described in, for example, WO 91/15528 A1, page 3, line 21 to page 20, line 33, and DE 4437535 A1, page 2, line 27 to page 6, line 22. The described polymers as binders are preferably hydroxy-functional and especially preferably possess an OH number in the range from 15 to 200 mg KOH/g, more preferably from 20 to 150 mg KOH/g. The basecoat materials more preferably comprise at least one hydroxy-functional polyurethane-polyacrylate copolymer, more preferably still at least one hydroxy-functional polyurethane-polyacrylate copolymer and also at least one hydroxy-functional polyester.

The proportion of the further polymers as binders may vary widely and is situated preferably in the range from 1.0 to 25.0 wt %, more preferably 3.0 to 20.0 wt %, very preferably 5.0 to 15.0 wt %, based in each case on the total weight of the basecoat material.

The basecoat material according to the invention may further comprise at least one typical crosslinking agent known per se. If it comprises a crosslinking agent, said agent comprises preferably at least one aminoplast resin and/or at least one blocked polyisocyanate, preferably an aminoplast resin. Among the aminoplast resins, melamine resins in particular are preferred.

If the basecoat material does comprise crosslinking agents, the proportion of these crosslinking agents, more particularly aminoplast resins and/or blocked polyisocyanates, very preferably aminoplast resins and, of these, preferably melamine resins, is preferably in the range from 0.5 to 20.0 wt %, more preferably 1.0 to 15.0 wt %, very preferably 1.5 to 10.0 wt %, based in each case on the total weight of the basecoat material.

The basecoat material may further comprise at least one thickener. Suitable thickeners are inorganic thickeners from the group of the phyllosilicates such as lithium aluminum magnesium silicates. Likewise, the basecoat material may comprise at least one organic thickener, as for example a (meth)acrylic acid-(meth)acrylate copolymer thickener or a polyurethane thickener. Employed for example here may be conventional organic associative thickeners, such as the known associative polyurethane thickeners, for example. Associative thickeners, as is known, are termed water-soluble polymers which have strongly hydrophobic groups at the chain ends or in side chains, and/or whose hydrophilic chains contain hydrophobic blocks or concentrations in their interior. As a result, these polymers possess a surfactant character and are capable of forming micelles in aqueous phase. In similarity with the surfactants, the hydrophilic regions remain in the aqueous phase, while the hydrophobic regions enter into the particles of polymer dispersions, adsorb on the surface of other solid particles such as pigments and/or fillers, and/or form micelles in the aqueous phase. Ultimately a thickening effect is achieved, without any increase in sedimentation behavior.

Thickeners as stated are available commercially. The proportion of the thickeners is preferably in the range from 0.1 to 5.0 wt %, more preferably 0.2 to 3.0 wt %, very preferably 0.3 to 2.0 wt %, based in each case on the total weight of the basecoat material.

Furthermore, the basecoat material may further comprise at least one further adjuvant. Examples of such adjuvants are salts which are thermally decomposable without residue or substantially without residue, polymers as binders that are curable physically, thermally and/or with actinic radiation and that are different from the polymers already stated as binders, further crosslinking agents, organic solvents, reactive diluents, transparent pigments, fillers, molecularly dispersely soluble dyes, nanoparticles, light stabilizers, antioxidants, deaerating agents, emulsifiers, slip additives, polymerization inhibitors, initiators of radical polymerizations, adhesion promoters, flow control agents, film-forming assistants, sag control agents (SCAs), flame retardants, corrosion inhibitors, waxes, siccatives, biocides, and matting agents. Such adjuvants are used in the customary and known amounts.

The solids content of the basecoat material may vary according to the requirements of the case in hand. The solids content is guided primarily by the viscosity that is needed for application, more particularly spray application. A particular advantage is that the basecoat material for inventive use, at comparatively high solids contents, is able nevertheless to have a viscosity which allows appropriate application.

The solids content of the basecoat material is preferably at least 16.5%, more preferably at least 18.0%, even more preferably at least 20.0%.

Under the stated conditions, in other words at the stated solids contents, preferred basecoat materials have a viscosity of 40 to 150 mPas, more particularly 70 to 120 mPas, at 23° C. under a shearing load of 1000 1/s (for further details regarding the measurement method, see Examples section). For the purposes of the present invention, a viscosity within this range under the stated shearing load is referred to as spray viscosity (working viscosity). As is known, coating materials are applied at spray viscosity, meaning that under the conditions then present (high shearing load) they possess a viscosity which in particular is not too high, so as to permit effective application. This means that the setting of the spray viscosity is important, in order to allow a paint to be applied at all by spray methods, and to ensure that a complete, uniform coating film is able to form on the substrate to be coated.

The basecoat material for inventive use is aqueous (regarding the fundamental definition of “aqueous”, see above).

The fraction of water in the basecoat material is preferably from 35 to 70 wt %, and more preferably 45 to 65 wt %, based in each case on the total weight of the basecoat material.

Even more preferred is for the percentage sum of the solids content of the basecoat material and the fraction of water in the basecoat material to be at least 70 wt %, preferably at least 75 wt %. Among these figures, preference is given to ranges of 75 to 95 wt %, in particular 80 to 90 wt %.

This means in particular that preferred basecoat materials comprise components that are in principle a burden on the environment, such as organic solvents in particular, in relation to the solids content of the basecoat material, at only low fractions. The ratio of the volatile organic fraction of the basecoat material (in wt %) to the solids content of the basecoat material (in analogy to the representation above, here in wt %) is preferably from 0.05 to 0.7, more preferably from 0.15 to 0.6. In the context of the present invention, the volatile organic fraction is considered to be that fraction of the basecoat material that is considered neither part of the water fraction nor part of the solids content.

Another advantage of the basecoat material is that it can be prepared without the use of eco-unfriendly and health-injurious organic solvents such as N-methyl-2-pyrrolidone, dimethylformamide, dioxane, tetrahydrofuran, and N-ethyl-2-pyrrolidone. Accordingly, the basecoat material preferably contains less than 10 wt %, more preferably less than 5 wt %, more preferably still less than 2.5 wt % of organic solvents selected from the group consisting of N-methyl-2-pyrrolidone, dimethylformamide, dioxane, tetrahydrofuran, and N-ethyl-2-pyrrolidone. The basecoat material is preferably entirely free from these organic solvents.

The ratio of the fraction of the one or more dispersions (PD) to the fraction of the at least one dispersion (wD), based in each case on the total weight of the aqueous basecoat material of the invention, may be adapted according to the requirements of the individual case and may vary within a wide range. The same is therefore true of the ratio between the fractions of the polymers originating from the dispersions (PD) and (wD) (determined in each case via the solids content).

The basecoat materials can be produced using the mixing assemblies and mixing techniques that are customary and known for the production of basecoat materials.

Further provided by the present invention is a method for producing a multicoat paint system, which involves producing at least one basecoat film using at least one aqueous basecoat material of the invention.

All of the statements made above concerning the basecoat material of the invention are also valid for the method of the invention. This is the case in particular not least for all preferred, more preferred, and very preferred features. With particular preference the basecoat material comprises a pigment, and is therefore pigmented.

Provided accordingly with the present invention is a method in which
(1) an aqueous basecoat material is applied to a substrate,
(2) a polymer film is formed from the coating material applied in stage (1),
(3) a clearcoat material is applied to the resulting basecoat film, and then
(4) the basecoat film is cured together with the clearcoat film,
   wherein the aqueous basecoat material used in stage (1) is a basecoat material of the invention.

The stated method is used preferably to produce multicoat color paint systems, effect paint systems, and color and effect paint systems.

The aqueous basecoat material for inventive use is commonly applied to metallic or plastics substrates that have been pretreated with surfacer or primer-surfacer. Optionally said basecoat material may also be applied directly to the plastics substrate.

Where a metal substrate is to be coated, it is preferably coated additionally with an electrocoat system before the surfacer or primer-surfacer is applied.

Where a plastics substrate is being coated, it is preferably given, additionally, a surface-activating pretreatment before the surfacer or primer-surfacer is applied. The methods most commonly used for such pretreatment are flaming, plasma treatment, corona discharge. Flaming is used with preference.

Application of the aqueous basecoat material of the invention to a metal substrate may take place in the film thicknesses customary in the automobile industry in the range from, for example, 5 to 100 micrometers, preferably 5 to 60 micrometers. This is done using spray application methods, such as, for example, compressed air spraying, airless spraying, high-speed rotation, electrostatic spray application (ESTA), alone or in conjunction with hot spray application such as hot air spraying, for example.

After the aqueous basecoat material has been applied, it can be dried by known methods. For example, (one-component) basecoat materials, which are preferred, may be flashed at room temperature for 1 to 60 minutes and subsequently dried, preferably at optionally slightly elevated temperatures of 30 to 90° C. Flashing and drying in the context of the present invention may be evaporation of organic solvents and/or water, as a result of which the paint becomes drier but has not yet cured or not yet formed a fully crosslinked coating film.

Then a commercial clearcoat material is applied, by likewise common methods, the film thicknesses again being within the usual ranges, of 5 to 100 micrometers for example. Two-component clearcoat materials are preferred.

After the clearcoat material has been applied, it can be flashed at room temperature for 1 to 60 minutes, for example, and optionally dried. The clearcoat is then cured together with the applied basecoat. Here, for example, crosslinking reactions take place, producing a multicoat color and/or effect paint system of the invention on a substrate. Curing takes place preferably thermally at temperatures of 60 to 200° C.

All of the film thicknesses reported in the context of the present invention are understood as dry film thicknesses. The film thickness is therefore that of the cured coat in each case. Where, then, it is reported that a coating material is applied in a particular film thickness, this means that the coating material is applied in such a way that the stated film thickness is achieved after curing.

Plastics substrates are coated basically in the same way as for metal substrates. Here, however, curing takes place generally at much lower temperatures, of 30 to 90° C., so as not to cause damage and/or deformation of the substrate.

By means of the method of the invention, therefore, it is possible for metallic and nonmetallic substrates, especially plastics substrates, preferably automobile bodies or parts thereof, to be painted.

In one particular embodiment of the method of the invention, one fewer curing step is carried out in comparison to a standard procedure, as already described at the outset. This means in particular that a coating system for joint curing, comprising one or at least two basecoat films, in other words, at any rate, a first basecoat and a second basecoat, and also a clearcoat, is built up on the substrate and then jointly cured. At least one of the basecoats used in this system is a basecoat material of the invention. In a system comprising at least two basecoat films, therefore, the first basecoat or the second basecoat may be a basecoat material of the invention. Equally possible, and preferred for the purposes of the present invention, is for both basecoats to be basecoat materials of the invention.

The system described here is built up, for example, on a plastics substrate which has optionally been given a surface-activating pretreatment, or on a metal substrate provided with a cured electrocoat system.

Particularly preferred in this case is construction on metal substrates provided with a cured electrocoat film. In this embodiment, therefore, it is critical that all of the coating compositions applied to the cured electrocoat system are jointly cured. Although, of course, separate flashing and/or interim drying is possible, none of the films is converted into the cured state separately.

Curing and cured state are understood for the purposes of the present invention in accordance with their general interpretation by a skilled person. Accordingly, the curing of a coating film means the conversion of such a film into the ready-to-use state, in other words into a state in which the substrate equipped with the coating film in question can be transported, stored, and put to its intended use. A cured coating film, therefore, in particular is no longer soft or tacky, but is instead conditioned as a solid coating film, which no longer undergoes any substantial alteration in its properties such as hardness or substrate adhesion, even when further exposed to curing conditions as described later on below.

The present invention also provides a method for refinishing multicoat paint systems, especially those produced by the method described above.

This method, accordingly, is a method for refinishing a multicoat paint system wherein one or, in succession, at least two basecoat film(s) and thereafter a clearcoat film are produced on a substrate, the substrate used being a multicoat paint system possessing defects, and all coating compositions applied during the refinish method being jointly cured. At least one of the basecoat materials used is then a basecoat material of the invention.

As is known, it is customary, and hence also possible as part of the refinish method, for the defects to be sanded beforehand. It is also customary and possible for the refinish method to be used only for the local renovation of defects (spot repair) or for the complete refinishing of a multicoat paint system bearing defects (dual finishing).

The use of basecoat materials of the invention results in multicoat paint systems which as well as excellent esthetic properties also have very good adhesion properties. This is so both for the original finishing sector and for refinishing.

### EXAMPLES

### Description of Methods

### 1. Solids Content (Solids, Nonvolatile Fraction)

The nonvolatile fraction is determined according to DIN EN ISO 3251 (date: June 2008). This involves weighing out 1 g of sample into an aluminum dish which has been dried beforehand, drying it in a drying oven at 125° C. for 60 minutes, cooling it in a desiccator, and then reweighing it. The residue relative to the total amount of sample used corresponds to the nonvolatile fraction. The volume of the nonvolatile fraction may optionally be determined if necessary according to DIN 53219 (date: August 2009).

### 2. Film Thicknesses

The film thicknesses are determined according to DIN EN ISO 2808 (date: May 2007), method 12A, using the MiniTest® 3100-4100 instrument from ElektroPhysik.

### 3. Determination of Storage Stability

For determination of the storage stability of coating compositions, they are investigated before and after the storage at 40° C. for 2 weeks, using a rotational viscometer conforming to DIN 53019-1 (date: September 2008) and calibrated according to DIN 53019-2 (date: February 2001), under controlled temperature conditions (23.0° C.±0.2° C.). The samples are subjected to shearing first for 5 minutes at a shear rate of 1000 s⁻¹ (loading phase) and then for 8 minutes at a shear rate of 1 s⁻¹ (unloading phase).

The average viscosity level during the loading phase (high-shear viscosity) and also the level after 8 minutes of unloading phase (low-shear viscosity) are determined from the measured data, and the values before and after storage are compared with one another by calculation of the respective percentage changes. A change in amount terms of 15% at most is considered acceptable.

### 4. Assessment of the Incidence of Pops and Runs

To determine the propensity toward popping and running, in accordance with DIN EN ISO 28199-1 (date: January 2010) and DIN EN ISO 28199-3 (date: January 2010), multicoat paint systems are produced according to the following general protocol: A perforated steel panel coated with a cured cathodic electrocoat (CEC) (CathoGuard® 800 from BASF Coatings GmbH), with dimensions of 57 cm×20 cm (according to DIN EN ISO 28199-1, section 8.1, version A) is prepared in analogy to DIN EN ISO 28199-1, section 8.2 (version A). Subsequently, in accordance with DIN EN ISO 28199-1, section 8.3, an aqueous basecoat material is applied in a single application electrostatically, in the form of a wedge, with a target film thickness (film thickness of the dried material) in the range from 0 μm to 40 μm. After a flashing time at 18-23° C. of 10 minutes (running test) or without a prior flashing time (popping test), the resulting basecoat film is subjected to interim drying in a forced air oven at 80° C. for 5 minutes. In the case of the test for runs, the panels are flashed and interim-dried in a vertical position.

The determination of the popping limit, i.e., of the basecoat film thickness from which pops occur, is made according to DIN EN ISO 28199-3, section 5.

The determination of the running tendency is carried out according to DIN EN ISO 28199-3, section 4. As well as the film thickness at which a run exceeds a length of 10 mm from the bottom edge of the perforation, a determination is made of the film thickness above which an initial tendency to run can be observed visually at a perforation.

### 5. Painting of Waterborne Basecoat Material Wedge Constructions

To assess the incidence of pinholes and also the leveling as a function of film thickness, wedge-format multicoat paint systems are produced in accordance with the following general protocols:

Variant A: First Waterborne Basecoat Material as Wedge, Second Waterborne Basecoat Material as Constant Coat A steel panel with dimensions of 30×50 cm, coated with a cured standard CEC (CathoGuard® 800 from BASF Coatings), is provided with two adhesive strips (Tesaband adhesive tape, 19 mm) at one longitudinal edge, to allow determination of film thickness differences after coating.

The first waterborne basecoat material is applied electrostatically as a wedge with a target film thickness (film thickness of the dried material) of 0-30 μm. After flashing at room temperature for 3 minutes, one of the two adhesive strips is removed and then the second waterborne basecoat material is applied likewise electrostatically in a single application. The target film thickness (film thickness of the dried material) is 13-16 μm. After a further flashing time of 4 minutes at room temperature, the system is interim-dried in a forced air oven at 60° C. for 10 minutes.

Following removal of the second adhesive strip, a commercial two-component clearcoat material (ProGloss® from BASF Coatings GmbH) is applied by gravity-fed spray gun manually to the interim-dried system, with a target film thickness (film thickness of the dried material) of 40-45 μm. The resulting clearcoat film is flashed at room temperature (18 to 23° C.) for 10 minutes; subsequently, curing takes place in a forced air oven at 140° C. for a further 20 minutes.

### Variant B: First Waterborne Basecoat Material as Constant Coat, Second Waterborne Basecoat Material as Wedge

A steel panel with dimensions of 30×50 cm, coated with a cured standard CEC (CathoGuard® 800 from BASF Coatings), is provided with two adhesive strips (Tesaband adhesive tape, 19 mm) at one longitudinal edge, to allow determination of film thickness differences after coating.

The first waterborne basecoat material is applied electrostatically with a target film thickness (film thickness of the dried material) of 18-22 μm. After flashing at room temperature for 3 minutes, one of the two adhesive strips is removed and then the second waterborne basecoat material is applied likewise electrostatically in a single application as a wedge. The target film thickness (film thickness of the dried material) is 0-30 μm. After a further flashing time of 4 minutes at room temperature, the system is interim-dried in a forced air oven at 60° C. for 10 minutes.

Following removal of the second adhesive strip, a commercial two-component clearcoat material (ProGloss® from BASF Coatings GmbH) is applied by gravity-fed spray gun manually to the interim-dried system, with a target film thickness (film thickness of the dried material) of 40-45 μm. The resulting clearcoat film is flashed at room temperature (18 to 23° C.) for 10 minutes; subsequently, curing takes place in a forced air oven at 140° C. for a further 20 minutes.

### Variant C: One Waterborne Basecoat Material as Wedge

A steel panel with dimensions of 30×50 cm, coated with a cured standard CEC (CathoGuard® 800 from BASF Coatings), is provided with two adhesive strips (Tesaband adhesive tape, 19 mm) at one longitudinal edge, to allow determination of film thickness differences after coating.

The waterborne basecoat material is applied electrostatically as a wedge with a target film thickness (film thickness of the dried material) of 0-30 μm. After a flashing time of 4 minutes at room temperature, the system is interim-dried in a forced air oven at 80° C. for 10 minutes.

Following removal of the adhesive strip, a commercial two-component clearcoat material (ProGloss® from BASF Coatings GmbH) is applied by gravity-fed spray gun manually to the interim-dried waterborne basecoat film, with a target film thickness (film thickness of the dried material) of 40-45 μm. The resulting clearcoat film is flashed at room temperature (18 to 23° C.) for 10 minutes; subsequently, curing takes place in a forced air oven at 140° C. for a further 20 minutes.

### 6. Assessment of the Incidence of Pinholes

To assess the incidence of pinholes, multicoat paint systems are produced as per the methods for the painting of waterborne basecoat wedge systems (variants A and B, respectively), and are then evaluated visually according to the following general protocol:

The dry film thickness of the overall waterborne basecoat material system, consisting of the first and second waterborne basecoat materials, is checked and, for the basecoat film thickness wedge, the 0-20 μm region and the region from 20 μm to the end of the wedge are marked on the steel panel.

The pinholes are evaluated visually in the two separate regions of the waterborne basecoat wedge. The number of pinholes per region is counted. All results are standardized to an area of 200 cm². In addition, optionally, a record is made of that dry film thickness of the waterborne basecoat material wedge from which pinholes no longer occur.

7. Assessment of the Adhesion Properties after Condensation

For the assessment of condensation resistance, the samples under investigation are stored in a conditioning chamber under CH test conditions according to DIN EN ISO 6270-2:2005-09 over a period of 10 days. The respective metal panels were then assessed visually, both one hour and 24 hours after removal from the conditioning chamber, for blistering and also for the adhesion properties.

The incidence of blisters was assessed as follows by a combination of two values:
The number of blisters was evaluated by a quantity figure from 1 to 5, with m1 denoting a few blisters and m5 very many blisters.
The size of the blisters was evaluated by a size figure again from 1 to 5, with g1 denoting very small blisters and g5 very large blisters.
   The designation mOg0, accordingly, means a blister-free coating after condensation at storage, and represents an OK result in terms of blistering.

The stonechip adhesion after condensation exposure was investigated according to DIN EN ISO 20567-1, method B. The resulting damage pattern was likewise assessed under DIN EN ISO 20567-1.

Additionally, steam jet tests were conducted according to DIN 55662, method B. The scratches (in a diagonal cross) were made with a Sikkens scratch needle (see DIN EN ISO 17872 Annex A). The assessment of the steam jet test results was made according to DIN 55662, and in particular the maximum width of the detachments in millimeters was ascertained.

Furthermore, steam jet tests according to DIN 55662, method B (a diagonal cross made with a Sikkens scratch needle according to DIN EN ISO 17872 Annex A) were carried out on substrates which had previously undergone a stonechip test to DIN EN ISO 20567-1, method B. For the visual evaluation of the damage pattern, the following scale was utilized:

KW0=no change in the sample
KW1=slight washout of the damage present
KW2=clearly visible washout of the damage present in a coating film
KW3=complete disbonding of a coating film in the region of the jet
KW4=complete disbonding of a coating film beyond the jet region
KW5=detachment of the entire coating film down to the substrate

### 8. Isocyanate Content

The isocyanate content, also referred to below as NCO content, is determined by adding an excess of a 2% N,N-dibutylamine solution in xylene to a homogeneous solution of the samples in acetone/N-ethylpyrrolidone (1:1 vol %) and by potentiometric back-titration of the excess amine with 0.1N hydrochloric acid in a method based on DIN EN ISO 3251, DIN EN ISO 11909, and DIN EN ISO 14896. From the fraction of a polymer (solids) in solution it is possible to calculate back to the NCO content of the polymer, based on solids content.

### 9. Hydroxyl Number

The hydroxyl number was determined in a method based on R.-P. Kruger, R. Gnauck, and R. Algeier, Plaste and Kautschuk, 20, 274 (1982), using acetic anhydride in the presence of 4-dimethylaminopyridine as catalyst in a tetrahydrofuran (THF)/dimethylformamide (DMF) solution at room temperature; the excess acetic anhydride remaining after acetylation was hydrolyzed fully and the acetic acid was back-titrated potentiometrically with alcoholic potassium hydroxide solution. Acetylation times of 60 minutes were enough in all cases to guarantee complete reaction.

### 10. Acid Number

The acid number was determined with a method based on DIN EN ISO 2114 in homogeneous solution of tetrahydrofuran (THF)/water (9 parts by volume of THF and 1 part by volume of distilled water) using ethanolic potassium hydroxide solution.

### 11. Amine Equivalent Mass

The amine equivalent mass (solution) is used to determine the amine content of a solution, and was ascertained as follows. The sample under analysis was dissolved in glacial acetic acid at room temperature and titrated against 0.1N perchloric acid in glacial acetic acid in the presence of crystal violet. The initial mass of the sample and the consumption of perchloric acid give the amine equivalent mass (solution), the mass of the solution of the basic amine that is needed in order to neutralize one mole of chloric acid.

### 12. Degree of Masking of the Primary Amino Groups

The degree of masking of the primary amino groups was determined by means of IR spectrometry using a Nexus FT-IR spectrometer (from Nicolet) and an IR cell (d=25 mm, KBr window) at the absorption maximum at 3310 cm⁻¹), on the basis of concentration series of the amines used, with standardization to the absorption maximum at 1166 cm⁻¹ (internal standard) at 25° C.

### 13. Solvent Content

The amount of an organic solvent in a mixture, such as an aqueous dispersion, for example, was determined by gas chromatography (Agilent 7890A, 50 m silica capillary column with polyethylene glycol phase or 50 m silica capillary column with polydimethylsiloxane phase, helium carrier gas, split injector 250° C., oven temperature 40-220° C., flame ionization detector, detector temperature 275° C., internal standard n-propyl glycol).

### 14. Number-Average Molecular Weight

The number-average molar mass (Mₙ) was determined unless otherwise specified using a vapor pressure osmometer 10.00 (from Knauer) on concentration series in toluene at 50° C. with benzophenone as calibration substance for the determination of the experimental calibration constant of the instrument used, in accordance with E. Schröder, G. Müller, K.-F. Arndt, “Leitfaden der Polymercharakterisierung”, Akademie-Verlag, Berlin, pp. 47-54, 1982.

### 15. Average Size of the Particles in the Dispersion (PD)

The average particle size (volume average) of the polyurethane-polyurea particles present in the dispersions (PD) for inventive use is determined for the purposes of the present invention by photon correlation spectroscopy (PCS) in a method based on DIN ISO 13321.

Employed specifically for the measurement was a Malvern Nano S90 (from Malvern Instruments) at 25±1° C. The instrument covers a size range from 3 to 3000 nm and was equipped with a 4 mW He—Ne laser at 633 nm. The dispersions (PD) were diluted with particle-free, deionized water as dispersion medium to an extent such as to allow them to be measured subsequently in a 1 ml polystyrene cell with appropriate scattering intensity. Evaluation took place using a digital correlator, with the aid of the Zetasizer evaluation software, version 7.11 (from Malvern Instruments). Measurement took place five times, and the measurements were repeated on a second, freshly prepared sample. The standard deviation of a 5-fold determination was ≤4%. The maximum deviation in the arithmetic mean of the volume average (V-average mean) of five individual measurements was ±15%. The reported average particle size (volume average) is the arithmetic mean of the average particle size (volume average) of the individual preparations. The investigation was carried out using polystyrene standards having certified particle sizes between 50 to 3000 nm.

Obviously, the measurement and evaluation method described here was likewise used for determining the particle size of the polymer present in the aqueous dispersion (wD).

### 16. Gel Fraction

For the purposes of the present invention, the gel fraction was determined gravimetrically. Here, first of all, the polymer present in a sample, more particularly in an aqueous dispersion (PD) (initial mass 1.0 g) was isolated by freeze drying. Following determination of the solidification temperature, the temperature above which there is no longer any change in the electrical resistance of the sample when the temperature is lowered further, the fully-frozen sample underwent major drying, customarily in the pressure range of the drying vacuum, between 5 mbar and 0.05 mbar, at a drying temperature lower by 10° C. than the solidification temperature. Through gradual raising of the temperature of the heated placement surfaces to 25° C., the polymer was rapidly freeze-dried, and, after a drying time of typically 12 hours, the amount of polymer isolated (solid fraction, determined via the freeze drying) was constant and did not undergo any further change even after prolonged freeze drying. After-drying at a placement-surface temperature of 30° C. under maximally reduced ambient pressure (typically between 0.05 and 0.03 mbar) produced optimum drying of the polymer.

The isolated polymer was subsequently sintered in a forced air oven at 130° C. for one minute and thereafter extracted in an excess of tetrahydrofuran (ratio of tetrahydrofuran to solid fraction=300:1) at 25° C. for 24 hours. The insoluble fraction of the isolated polymer (gel fraction) was then separated off on a suitable frit, dried in a forced air oven at 50° C. for 4 hours, and then weighed again.

It was further ensured that at the sintering temperature of 130° C. with variation of the sintering times between one minute and 20 minutes, the gel fraction found for the microgel particles is independent of the sintering time. This therefore rules out any further increase in the gel fraction in crosslinking reactions subsequent to the isolation of the polymeric solid.

The gel fraction determined in this way in accordance with the invention is also called gel fraction (freeze-dried), and can also be reported in wt %. The reason is, evidently, that this is the weight-based fraction of polymer particles which has undergone crosslinking as described at the outset in connection with the dispersion (PD), and which therefore can be isolated as a gel.

In parallel, a gel fraction, also referred to below as gel fraction (130° C.), was determined gravimetrically by isolating a polymer sample from aqueous dispersion (initial mass 1.0 g) at 130° C. for 60 minutes (solid content). The mass of the polymer was determined before, in a procedure analogous to that described above, the polymer was extracted in excess to tetrahydrofuran at 25° C. for 24 hours and the insoluble fraction (gel fraction) was isolated, dried, and reweighed.

### 17. Solubility in Water

The solubility of an organic solvent in water was determined as follows at 20° C. The organic solvent in question and water were combined in a suitable glass vessel and mixed, and the mixture was subsequently equilibrated. The amounts of water and the solvent here were selected so that equilibration resulted in two separate phases. Following equilibration, a syringe is used to take a sample from the aqueous phase (that is, the phase containing more water than organic solvent), and this sample was diluted 1/10 with tetrahydrofuran, and the fraction of the solvent was determined by gas chromatography (for conditions see section 8. Solvent content).

If two phases do not form, independently of the amounts of water and of the solvent, the solvent is miscible with water in any weight ratio. This therefore infinitely water-soluble solvent (acetone, for example) is therefore not a solvent (Z.2) in any case.

### Preparation of Aqueous Dispersions (wD) and (PD)

### Dispersions (wD)

The preparation protocol described below refers to table A.

### Monomer Mixture (A), Stage i.

80 wt % of items 1 and 2 from table A are introduced into a steel reactor (5 L volume) with reflux condenser and heated to 80° C. The remaining fractions of the components listed under “Initial charge” in table A are premixed in a separate vessel. This mixture and, separately from it, the initiator solution (table A, items 5 and 6) are added dropwise to the reactor simultaneously over the course of 20 minutes, the fraction of the monomers in the reaction solution, based on the total amount of monomers used in step i., not exceeding 6.0 wt % throughout the entire reaction time. Subsequently, stirring takes place for 30 minutes.

### Monomer Mixture (B), Stage ii.

The components indicated under “Mono 1” in table A are premixed in a separate vessel. This mixture is added dropwise to the reactor over the course of 2 hours, with the fraction of the monomers in the reaction solution, based on the total amount of monomers used in stage ii., not exceeding 6.0 wt % throughout the entire reaction time. Subsequently, stirring is carried out for 1 hour.

### Monomer Mixture (C), Stage iii.

The components indicated under “Mono 2” in table A are premixed in a separate vessel. This mixture is added dropwise to the reactor over the course of 1 hour, with the fraction of the monomers in the reaction solution, based on the total amount of monomers used in stage iii., not exceeding 6.0 wt % throughout the entire reaction time. Subsequently, stirring is carried out for 2 hours.

Thereafter the reaction mixture is cooled to 60° C. and the neutralizing mixture (table A, items 20, 21, and 22) is premixed in a separate vessel. The neutralizing mixture is added dropwise to the reactor over the course of 40 minutes, during which the pH of the reaction solution is adjusted to a value of 7.5 to 8.5. The reaction product is subsequently stirred for 30 minutes more, cooled to 25° C., and filtered.

TABLE A
Aqueous dispersions (wD)

| | | BM2* | BM3* | BM4 | BM5 | BM6 | BM7 |
|---|---|---|---|---|---|---|---|
| | Initial charge | | | | | | |
| 1 | DI water | 41.81 | 41.81 | 41.81 | 41.81 | 41.81 | 41.81 |
| 2 | EF 800 | 0.18 | 0.18 | 0.18 | 0.18 | 0.18 | 0.18 |
| 3 | Styrene | 0.68 | 0.93 | 0.93 | 0.93 | 0.23 | 0.23 |
| 4 | n-Butyl acrylate | 0.48 | 0.23 | 0.23 | 0.23 | 0.93 | 0.93 |
| | Initiator solution | | | | | | |
| 5 | DI water | 0.53 | 0.53 | 0.53 | 0.53 | 0.53 | 0.53 |
| 6 | APS | 0.02 | 0.02 | 0.02 | 0.02 | 0.02 | 0.02 |
| | Mono 1 | | | | | | |
| 7 | DI water | 12.78 | 12.78 | 12.78 | 12.78 | 12.78 | 12.78 |
| 8 | EF 800 | 0.15 | 0.15 | 0.15 | 0.15 | 0.15 | 0.15 |
| 9 | APS | 0.02 | 0.02 | 0.02 | 0.02 | 0.02 | 0.02 |
| 10 | Styrene | 5.61 | 5.61 | 12.41 | 12.41 | 12.41 | 12.41 |
| 11 | n-Butyl acrylate | 13.6 | 13.6 | 6.8 | 6.8 | 6.8 | 6.8 |
| 12 | 1,6-HDDA | 0.34 | 0.34 | 0.34 | 0.34 | 0.34 | 0.34 |
| | Mono 2 | | | | | | |
| 13 | DI water | 5.73 | 5.73 | 5.73 | 5.73 | 5.73 | 5.73 |
| 14 | EF 800 | 0.07 | 0.07 | 0.07 | 0.07 | 0.07 | 0.07 |
| 15 | APS | 0.02 | 0.02 | 0.02 | 0.02 | 0.02 | 0.02 |
| 16 | Methacrylic acid | 0.71 | 0.71 | 0.71 | 0.71 | 0.71 | 0.71 |
| 17 | 2-HEA | 0.95 | 0.95 | 0.95 | 0.95 | 0.95 | 0.95 |
| 18 | n-Butyl acrylate | 3.74 | 1.87 | 3.74 | 1.87 | 3.74 | 1.87 |
| 19 | MMA | 0.58 | 2.45 | 0.58 | 2.45 | 0.58 | 2.45 |
| | Neutralization | | | | | | |
| 20 | DI water | 6.48 | 6.48 | 6.48 | 6.48 | 6.48 | 6.48 |
| 21 | Butyl glycol | 4.76 | 4.76 | 4.76 | 4.76 | 4.76 | 4.76 |
| 22 | DMEA | 0.76 | 0.76 | 0.76 | 0.76 | 0.76 | 0.76 |

*can be used as per the invention

The solids content was determined in order to monitor the reaction. The results are reported in table B:

TABLE B
Solids content of the aqueous dispersions

| | BM2* | BM3* | BM4 | BM5 | BM6 | BM7 |
|---|---|---|---|---|---|---|
| Solids content [%] | 25.5 | 25.5 | 25.5 | 26 | 27.4 | 26.1 |

*can be used as per the invention

After each stage and after the final neutralization, the particle size was determined. The results are reproduced in table C.

TABLE C
Particle sizes in nanometers

| | | BM2* | BM3* | BM4 | BM5 | BM6 | BM7 |
|---|---|---|---|---|---|---|---|
| i | After “Initial | 90 | 70 | 70 | 70 | 120 | 120 |
| | charge” | | | | | | |
| ii | After “Mono 1” | 150 | 160 | 160 | 180 | 150 | 160 |
| iii | After “Mono 2” | 190 | 230 | 230 | 250 | 220 | 200 |
| iiii | After | 240 | 290 | 275 | 300 | 250 | 245 |
| | neutralization | | | | | | |

*can be used as per the invention

Each of the indicated monomer mixtures (A), (B), and (C) (corresponding to “Initial charge”, “Mono 1”, and “Mono 2”) was polymerized individually and the respective glass transition temperature of the polymer obtained was then determined. Additionally, the glass transition temperature was determined for the entire polymer after neutralization.

The results are reported in table D.

TABLE D
Glass transition temperatures in ° C.

| | | BM2* | BM3* | BM4 | BM5 | BM6 | BM7 |
|---|---|---|---|---|---|---|---|
| i | “Initial charge” | 30 | 50 | 48 | 50 | −9 | −9 |
| ii | “Mono 1” | −11 | −12 | 45 | 45 | 47 | 48 |
| iii | “Mono 2” | 4 | 6 | 4 | 4 | 5 | 4 |
| | Entire polymer | −9 | −7 | 46 | 47 | 45 | 46 |

*can be used as per the invention

### Dispersion (PD)

A dispersion (PD1) was prepared as follows.

### a) Preparation of a Partly Neutralized Prepolymer Solution

A reaction vessel equipped with stirrer, internal thermometer, reflux condenser, and electrical heating was used to dissolve 559.7 parts by weight of a linear polyester polyol and 27.2 parts by weight dimethylolpropionoic acid (from GEO Speciality Chemicals) in 344.5 parts by weight of methyl ethyl ketone under nitrogen. The linear polyester diol was prepared beforehand from dimerized fatty acid (Pripol® 1012, from Croda), isophthalic acid (from BP Chemicals), and hexane-1,6-diol (from BASF SE) (weight ratio of the starting materials: dimeric fatty acid to isophthalic acid to hexane-1,6-diol=54.00:30.02:15.98) and had a hydroxyl number of 73 mg KOH/g solids fraction, an acid number of 3.5 mg KOH/g solids fraction, and a calculated, number-average molar mass of 1379 g/mol, and a number-average molar mass as determined by vapor pressure osmometry of 1350 g/mol.

The resulting solution was admixed at 30° C. in succession with 213.2 parts by weight of dicyclohexylmethane 4,4′-diisocyanate (Desmodur® W, from Bayer MaterialScience) having an isocyanate content of 32.0 wt % and with 3.8 parts by weight of dibutyltin dilaurate (from Merck). This was followed by heating to 80° C. with stirring. Stirring continued at this temperature until the isocyanate content of the solution was constant at 1.49 wt %. Thereafter 626.2 parts by weight of methyl ethyl ketone were added to the prepolymer and the reaction mixture was cooled to 40° C. When 40° C. had been reached, 11.8 parts by weight of triethylamine (from BASF SE) were added dropwise over the course of two minutes, and the batch was stirred for a further 5 minutes.

b) Reaction of the Prepolymer with Diethylenetriamine Diketimine

Subsequently 30.2 parts by weight of a 71.9 wt % dilution of diethylenetriamine diketimine in methyl isobutyl ketone (ratio of prepolymer isocyanate groups to diethylenetriamine diketimine (having one secondary amino group): 5:1 mol/mol, corresponding to two NCO groups per blocked primary amino group) were mixed in over a minute, during which the reaction temperature rose in a short time by 1° C. after addition of the prepolymer solution. The dilution of diethylenetriamine diketimine in methyl isobutyl ketone was prepared beforehand by azotropic removal of water of reaction during the reaction of diethyltriamine (from BASF SE) with methyl isobutyl ketone in methyl isobutyl ketone at 110-140° C. By dilution with methyl isobutyl ketone, the solution was adjusted to an amine equivalent mass of 124.0 g/eq. IR spectroscopy, using the residual absorption at 3310 cm⁻¹, found 98.5% blocking of the primary amino groups.

The solids content of isocyanate group-containing polymer solution was found to be 45.3%.

### c) Dispersing and Vacuum Distillation

After 30 minutes stirring at 40° C., the contents of the reactor was dispersed over 7 minutes into 1206 parts by weight of deionized water (23° C.). Methyl ethyl ketone was distilled off from the resulting dispersion under reduced pressure at 45° C., and any losses of solvent and water were compensated using deionized water, to result in a solids content of 40 wt %.

The result was a white, stable, high-solids, low-viscosity dispersion with crosslinked particles, which showed no sedimentation at all even after 3 months.

The resulting microgel dispersion (PD1) had the following characteristics:

| Solids content (130° C., 60 min, 1 g): | 40.2 | wt % |
|---|---|---|
| Methyl ethyl ketone content (GC): | 0.2 | wt % |
| Methyl isobutyl ketone content (GC): | 0.1 | wt % |
| Viscosity (23° C., rotational viscosimeter, | 15 | mPa · s |
| shear rate = 1000/s): | | |
| Acid number | 17.1 mg KOH/g | |
| | solids content | |
| Degree of neutralization (calculated) | 49% | |
| pH (23° C.) | 7.4 | |
| Particle size (photon correlation spectroscopy, | 167 | nm |
| volume average) | | |
| Gel fraction (freeze-dried) | 85.1 | wt % |
| Gel fraction (130° C.) | 87.3 | wt % |

### Preparation of Aqueous Basecoat Materials

The following should be taken into account regarding the formulation constituents and amounts thereof as indicted in the tables hereinafter. When reference is made to a commercial product or to a preparation protocol described elsewhere, the reference, independently of the principal designation selected for the constituent in question, is to precisely this commercial product or precisely the product prepared with the referenced protocol.

Accordingly, where a formulation constituent possesses the principal designation “melamine-formaldehyde resin” and where a commercial product is indicated for this constituent, the melamine-formaldehyde resin is used in the form of precisely this commercial product. Any further constituents present in the commercial product, such as solvents, must therefore be taken into account if conclusions are to be drawn about the amount of the active substance (of the melamine-formaldehyde resin).

If, therefore, reference is made to a preparation protocol for a formulation constituent, and if such preparation results, for example, in a polymer dispersion having a defined solids content, then precisely this dispersion is used. The overriding factor is not whether the principal designation that has been selected is the term “polymer dispersion” or merely the active substance, for example, “polymer”, “polyester”, or “polyurethane-modified polyacrylate”. This must be taken into account if conclusions are to be drawn concerning the amount of the active substance (of the polymer).

All proportions indicated in the tables are parts by weight.

### Pigment Pastes:

### Preparation of White Paste P1

The white paste is prepared from 50 parts by weight of titanium rutile 2310, 6 parts by weight of a polyester prepared as per example D, column 16, lines 37-59 of DE 40 09 858 A1, 24.7 parts by weight of a binder dispersion prepared as per patent application EP 022 8003 B2, page 8, lines 6 to 18, 10.5 parts by weight of deionized water, 4 parts by weight of 2,4,7,9-tetramethyl-5-decynediol, 52% in BG (available from BASE SE), 4.1 parts by weight of butyl glycol, 0.4 part by weight of 10% strength dimethylethanolamine in water, and 0.3 part by weight of Acrysol RM-8 (available from The Dow Chemical Company).

### Preparation of Black Paste P2

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

### Preparation of Talc Paste P3

The talc paste is prepared from 49.7 parts by weight of an aqueous binder dispersion prepared as per WO 91/15528, page 23, line 26 to page 25, line 24, 28.9 parts by weight of stearite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE), and 16.45 parts by weight of deionized water.

### Preparation of Barium Sulfate Paste P4

The barium sulfate paste was prepared from 39 parts by weight of a polyurethane dispersion prepared as per EP 0228003 B2, page 8, lines 6 to 18, 54 parts by weight of barium sulfate (Blanc fixe micro from Sachtleben Chemie GmbH), 3.7 parts by weight of butyl glycol, and 0.3 part by weight of Agitan 282 (available from Münzing Chemie GmbH) and 3 parts by weight of deionized water.

### Preparation of an Aluminum Pigment Slurry S1

The aluminum pigment slurry was obtained by using a stirring element to mix 50 parts by weight of butyl glycol and also 35 parts by weight of the commercial effect pigment Alu Stapa IL Hydrolan 2192 No. 5 and 15 parts by weight of the commercial effect pigment Alu Stapa IL Hydrolan 2197 No. 5 (each available from Altana-Eckart).

### Preparation of Inventive Basecoats WBM Gray A1 and WBM Gray A2

The components listed in table 1.1 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.1

| | WBM | WBM |
|---|---|---|
| | Gray | Gray |
| Component | A1 | A2 |
| 3% Na Mg phyllosilicate solution | 8.0 | 4.0 |
| Aqueous dispersion (wD) BM2 | 22.0 | 11.0 |
| Aqueous dispersion (PD1) | 13.1 | 26.3 |
| Melamine-formaldehyde resin (Cymel ® 203 from | 3.4 | 1.7 |
| Allnex) | | |
| Polyester; prepared as per page 28, lines 13 to 33 | 2.0 | 1.0 |
| (example BE1) of WO 2014/033135 A2 | | |
| Polyester; prepared as per example D, column 16, | 6.1 | 7.6 |
| lines 37-59 of DE 40 09 858 A1 | | |
| Polyurethane-modified polyacrylate; prepared as per | 2.2 | 4.4 |
| page 7, line 55 to page 8, line 23 of DE 4437535 A1 | | |
| Water, deionized | 9.0 | 9.0 |
| Butyl glycol | 3.8 | 3.6 |
| 1-Propoxy-2-propanol | 0.9 | 0.4 |
| Isopar ® L, available from Exxon Mobil | 1.1 | 0.6 |
| 2-Ethylhexanol | 0.5 | 0.3 |
| 2,4,7,9-Tetramethyl-5-decynediol, 52% in BG | 1.4 | 1.8 |
| (available from BASF SE) | | |
| 10% Dimethylethanolamine in water | 1.3 | 2.3 |
| Pluriol ® P900, available from BASF SE | 0.7 | 0.9 |
| Hydrosol A170, available from DHC Solvent Chemie | 0.3 | 0.2 |
| GmbH | | |
| White paste P1 | 25.0 | 25.0 |
| Black paste P2 | 1.5 | 1.5 |

### Preparation of Comparative Basecoats WBM Gray A3 and WBM Gray A4

The components listed in table 1.2 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.2

| | WBM | WBM |
|---|---|---|
| | Gray | Gray |
| Component | A3 | A4 |
| 3% Na Mg phyllosilicate solution | 12.0 | |
| Aqueous dispersion (wD) BM2 | 33.0 | |
| Aqueous dispersion (PD1) | | 39.4 |
| Melamine-formaldehyde resin (Cymel ® 203 from | 5.1 | |
| Allnex) | | |
| Polyester; prepared as per page 28, lines 13 to 33 | 3.0 | |
| (example BE1) of WO 2014/033135 A2 | | |
| Polyester; prepared as per example D, column 16, | 4.6 | 9.1 |
| lines 37-59 of DE 40 09 858 A1 | | |
| Polyurethane-modified polyacrylate; prepared as per | | 6.6 |
| page 7, line 55 to page 8, line 23 of DE 4437535 A1 | | |
| Water, deionized | 9.0 | 9.0 |
| Butyl glycol | 4.1 | 3.3 |
| 1-Propoxy-2-propanol | 1.3 | |
| Isopar ® L, available from Exxon Mobile | 1.7 | |
| 2-Ethylhexanol | 0.8 | |
| 2,4,7,9-Tetramethyl-5-decynediol, 52% in BG | 1.0 | 2.2 |
| (available from BASF SE) | | |
| 10% Dimethylethanolamine in water | 0.3 | 3.3 |
| Pluriol ® P900, available from BASF SE | 0.5 | 1.1 |
| Hydrosol A170, available from DHC Solvent Chemie | 0.5 | |
| GmbH | | |
| White paste P1 | 25.0 | 25.0 |
| Black paste P2 | 1.5 | 1.5 |

### Preparation of Inventive Basecoats WBM Silver B1 and WBM Silver B2

The components listed in table 1.3 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.3

| | WBM | WBM |
|---|---|---|
| | Silver | Silver |
| Component | B1 | B2 |
| 3% Na Mg phyllosilicate solution | 14.6 | 7.3 |
| Aqueous dispersion (wD) BM2 | 25.3 | 12.6 |
| Aqueous dispersion (PD1) | 10.7 | 21.3 |
| Melamine-formaldehyde resin (Cymel ® 203 from | 3.1 | 1.6 |
| Allnex) | | |
| Polyester; prepared as per example D, column 16, | 6.8 | 7.1 |
| lines 37-59 of DE 40 09 858 A1 | | |
| Polyurethane-modified polyacrylate; prepared as per | 5.5 | 5.4 |
| page 7, line 55 to page 8, line 23 of DE 4437535 A1 | | |
| Deionized water | 32.4 | 33.2 |
| Butyl glycol | 1.3 | 1.1 |
| 1-Propoxy-2-propanol | 2.2 | 1.1 |
| n-Butoxypropanol | 1.6 | 0.8 |
| Isobutanol | 2.7 | 1.4 |
| 2-Ethylhexanol | 2.5 | 1.2 |
| 2,4,7,9-Tetramethyl-5-decynediol, 52% in BG | 1.0 | 2.1 |
| (available from BASF SE) | | |
| 50 wt % strength solution of Rheovis ® PU1250 in | 0.5 | 0.2 |
| butyl glycol (Rheovis ® PU1250 available from | | |
| BASF SE) | | |
| Rheovis ® AS 1130, available from BASF SE | 1.1 | 1.1 |
| Aluminum pigment slurry S1 | 13.4 | 13.4 |
| 10% Dimethylethanolamine in water | 2.0 | 3.0 |
| Pluriol ® P900, available from BASF SE | 1.2 | 1.1 |
| Byketol ®-WS from Altana/BYK-Chemie GmbH | 0.9 | 0.5 |
| Dispex ® Ultra FA 4437, available from BASF SE | 0.1 | 0.3 |

### Preparation of Comparative Basecoats WBM Silver B3 and WBM Silver B4

The components listed in table 1.4 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.4

| | WBM | WBM |
|---|---|---|
| | Silver | Silver |
| Component | B3 | B4 |
| 3% Na Mg phyllosilicate solution | 21.9 | |
| Aqueous dispersion (wD) BM2 | 37.9 | |
| Aqueous dispersion (PD1) | | 32.0 |
| Melamine-formaldehyde resin (Cymel ® 203 from | 4.7 | |
| Allnex) | | |
| Polyester; prepared as per example D, column 16, | 6.5 | 7.4 |
| lines 37-59 of DE 40 09 858 A1 | | |
| Polyurethane-modified polyacrylate; prepared as per | 5.5 | 5.3 |
| page 7, line 55 to page 8, line 23 of DE 4437535 A1 | | |
| Deionized water | 31.5 | 34.1 |
| Butyl glycol | 1.4 | 1.0 |
| 1-Propoxy-2-propanol | 3.3 | |
| n-Butoxypropanol | 2.4 | |
| Isobutanol | 4.1 | |
| 2-Ethylhexanol | 3.7 | |
| 2,4,7,9-Tetramethyl-5-decynediol, 52% in BG | | 3.1 |
| (available from BASF SE) | | |
| 50 wt % strength solution of Rheovis ® PU1250 in | 0.7 | |
| butyl glycol (Rheovis ® PU1250 available from | | |
| BASF SE) | | |
| Rheovis ® AS 1130, available from BASF SE | 1.0 | 1.2 |
| Aluminum pigment slurry S1 | 13.4 | 13.4 |
| 10% Dimethylethanolamine in water | 1.0 | 4.0 |
| Pluriol ® P900, available from BASF SE | 1.4 | 0.9 |
| Byketol ®-WS from Altana/BYK-Chemie GmbH | 1.4 | |
| Dispex ® Ultra FA 4437, available from BASF SE | | 0.4 |

### Preparation of Inventive Basecoats WBM Black B5 to WBM Black B8

The components listed in table 1.5 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.5

| | WBM | WBM | WBM | WBM |
|---|---|---|---|---|
| | Black | Black | Black | Black |
| Component | B5 | B6 | B7 | B8 |
| 3% Na Mg phyllosilicate solution | 15.0 | 10.0 | 5.0 | 7.0 |
| Aqueous dispersion (wD) BM2 | 27.3 | 18.2 | 9.1 | 7.0 |
| Aqueous dispersion (PD1) | 6.3 | 12.5 | 18.8 | 14.1 |
| Melamine-formaldehyde resin | 6.9 | 6.9 | 6.9 | |
| (Cymel ® 203 from Allnex) | | | | |
| Polyester; prepared as per page | 3.1 | 3.1 | 3.1 | 2.3 |
| 28, lines 13 to 33 (example BE1) | | | | |
| of WO 2014/033135 A2 | | | | |
| Deionized water | 9.1 | 11.3 | 13.2 | 3.0 |
| Butyl glycol | 4.0 | 4.0 | 4.0 | 1.4 |
| 2-Ethylhexanol | 2.0 | 2.0 | 2.0 | 1.4 |
| 2,4,7,9-Tetramethyl-5-decynediol, | 0.3 | 0.2 | 0.1 | 0.2 |
| 52% in BG (available from BASF | | | | |
| SE) | | | | |
| 10% Dimethylethanolamine in | 0.1 | 0.2 | 0.2 | 0.3 |
| water | | | | |
| 50 wt % strength solution of | 0.1 | 0.1 | 0.1 | 0.5 |
| Rheovis ® PU1250 in butyl glycol | | | | |
| (Rheovis ® PU1250 available | | | | |
| from BASF SE) | | | | |
| Rheovis ® AS 1130, available | 0.3 | 0.3 | 0.3 | 0.1 |
| from BASF SE | | | | |
| Black paste P2 | 7.5 | 7.5 | 7.5 | 7.5 |
| Talc paste P3 | | | | 1.5 |

### Preparation of Inventive Basecoats WBM Black B9 and WBM Black B10

The components listed in table 1.6 are combined with stirring in the order stated to form an aqueous mixture. This mixture is then stirred for 10 minutes and adjusted using deionized water and dimethylethanolamine to a pH of 8 and to a spray viscosity of 90±10 mPa·s under a shearing load of 1000 s⁻¹, as measured using a rotational viscometer (Rheolab QC instrument with C-LTD80/QC heating system from Anton Paar) at 23° C.

TABLE 1.6

| | WBM | WBM |
|---|---|---|
| | Black | Black |
| Component | B9 | B10 |
| 3% Na Mg phyllosilicate solution | 7.6 | |
| Aqueous dispersion (wD) BM2 | 20.3 | |
| Aqueous dispersion (PD1) | | 22.9 |
| Melamine-formaldehyde resin (Cymel ® 203 from | 2.4 | |
| Allnex) | | |
| Polyester; prepared as per example D, column 16, | 1.7 | 5.3 |
| lines 37-59 of DE 40 09 858 A1 | | |
| Polyurethane-modified polyacrylate; prepared as per | 1.6 | 3.8 |
| page 7, line 55 to page 8, line 23 of DE 4437535 A1 | | |
| Deionized water | 6.1 | 7.2 |
| Butyl glycol | 0.6 | 1.9 |
| n-Propanol | 0.5 | |
| n-Butoxypropanol | 0.8 | |
| Isopropanol | 0.9 | |
| 2-Ethylhexanol | 1.6 | |
| Isopar ® L, available from Exxon Mobile | 0.5 | |
| 2,4,7,9-Tetramethyl-5-decynediol, 52% in BG | 0.8 | 1.3 |
| (available from BASF SE) | | |
| NACURE 2500, available from King Industries, Inc | 0.2 | |
| Black paste P2 | 7.5 | 7.5 |
| Talc paste P3 | 1.9 | |
| Barium sulfate paste P4 | 1.8 | |
| 10% Dimethylethanolamine in water | 0.2 | 1.6 |
| Pluriol ® P900, available from BASF SE | | 0.6 |
| BYK-346, available from Altana/BYK-Chemie GmbH | 0.3 | |

While the inventive basecoats each contain a combination of the two dispersions (PD) and (wD) (where different weight ratios of the two components are represented), the comparative basecoats contain only one of the two dispersions.

### Performance Investigations of the Basecoats and of Multicoat Paint Systems Produced Using the Basecoats

### Storage Stability, Runs, Pops:

All basecoat materials A1 to A4 and B1 to B10 were investigated using the methods described above for their storage stability and their running and popping behaviors. All materials proved to be storage-stable, no basecoat exhibited pops or runs.

### Pinholes:

The following wedge-format multicoat systems were produced according to the methods described above (variants A, B, and C) and then investigated (x=system produced, −=system absent):

| | Wedge coating | | |
|---|---|---|---|
| | Variant A | Variant B | Variant C |
| WBM Gray A1 with | X | X | — |
| WBM Silver B1 | | | |
| WBM Gray A2 with | X | X | — |
| WBM Silver B2 | | | |
| WBM Gray A3 with | X | X | — |
| WBM Silver B3 | | | |
| WBM Gray A4 with | X | X | — |
| WBM Silver B4 | | | |
| WBM Black B5 | — | — | x |
| WBM Black B6 | — | — | x |
| WBM Black B7 | — | — | x |
| WBM Black B8 | — | — | x |
| WBM Black B9 | — | — | x |
| WBM Black B10 | — | — | x |

Overall it was found that all of the basecoats lead to multicoat paint systems having outstanding optical and esthetic properties.

### Adhesion Properties:

A) The following general protocol was followed to simulate refinish systems in this way:

A perforated steel panel coated with a cured cathodic electrocoat (CEC) (CathoGuard® 800 from BASF Coatings GmbH), with dimensions of 57 cm×20 cm (according to DIN EN ISO 28199-1, section 8.1, version A) is prepared in analogy to DIN EN ISO 28199-1, section 8.2 (version A). Subsequently, in accordance with DIN EN ISO 28199-1, section 8.3, an aqueous basecoat material WBM Gray A1 to WBM Gray A4 is applied in a single application electrostatically in a target film thickness of 20 μm. After a flashing time at room temperature of 3 minutes, a second aqueous basecoat material (WBM Silver 1 to WBM Silver 4) is applied electrostatically (target film thickness 15 μm). After a further flashing time of 4 minutes at room temperature, the system is subjected to interim drying in a forced air oven at 60° C. for 5 minutes. Subsequently, using a gravity-fed spray gun, a commercial two-component clearcoat (ProGloss® from BASF Coatings GmbH) was applied manually to the interim-dried system, with a target film thickness of 40-45 μm. The resulting clearcoat film was flashed at room temperature for 10 minutes, followed by curing in a forced air oven at 140° C. for a further 20 minutes.

In a further step, the above-stated applications are repeated, so as to simulate a refinish system, which in practice is particularly critical in terms of adhesion. Consequently, the same system was produced once again, but in this case, obviously, the first basecoat material was applied not to the cured cathodic electrocoat film but instead to the previously produced multicoat paint system (or to the cured clearcoat film). Here, therefore, the original multilayer paint system served as substrate for the system.

The sole difference relative to the procedure identified above lay with the temperature of the concluding curing step. Whereas curing of the above took place at 140° C., the procedure at refinish involved two different sets of conditions, once under so-called underbake conditions (125° C. instead of 140° C.), and once under so-called overbake conditions (155° C. instead of 140° C.).

In all cases, condensation exposure left a blister-free system (m0g0). Further results are found in the table below.

| | | | | Steam jet | |
|---|---|---|---|---|---|
| | | Stonechip | | on stonechip | |
| | | Ref. | Ref. | Ref. | Ref. |
| | inventive | 125° C. | 155° C. | 125° C. | 155° C. |
| WBM Gray A1 with | yes | 1.5 | 2.0 | KW2 | KW1.5 |
| WBM Silver B1 | | | | | |
| WBM Gray A2 with | yes | 1.5 | 2.0 | KW2 | KW1 |
| WBM Silver B2 | | | | | |
| WBM Gray A3 with | no | 2.5 | 2.5 | KW2.5 | KW2.5 |
| WBM Silver B3 | | | | | |
| WBM Gray A4 with | no | 4.0 | 2.5 | KW4 | KW5 |
| WBM Silver B4 | | | | | |

The results show that using the basecoats of the invention, outstanding adhesion properties are obtained, which, moreover, are better than with the comparative systems.

B) The following general protocol was followed to simulate refinish systems in this way:

A perforated steel panel coated with a cured cathodic electrocoat (CEC) (CathoGuard® 800 from BASF Coatings GmbH), with dimensions of 57 cm×20 cm (according to DIN EN ISO 28199-1, section 8.1, version A) is prepared in analogy to DIN EN ISO 28199-1, section 8.2 (version A). Subsequently, in accordance with DIN EN ISO 28199-1, section 8.3, an aqueous basecoat material WBM Black B5 to WBM Black B10 is applied in a single application electrostatically in a target film thickness of 15 μm. After a flashing time of 4 minutes at room temperature, the system is subjected to interim drying in a forced air oven at 60° C. for 5 minutes. Subsequently, using a gravity-fed spray gun, a commercial two-component clearcoat (ProGloss® from BASF Coatings GmbH) was applied manually to the interim-dried system, with a target film thickness of 40-45 μm. The resulting clearcoat film was flashed at room temperature for 10 minutes, followed by curing in a forced air oven at 140° C. for a further 20 minutes.

In analogy to the procedure described under A), in a further step, the above-stated applications are repeated so as to simulate a refinish system. Again, the only difference from the procedure identified above lay with the temperature of the concluding curing step.

In all cases, condensation exposure left a blister-free system (m0g0). Further results are found in the table below.

| | | | | Steam jet | |
|---|---|---|---|---|---|
| | | Stonechip | | on stonechip | |
| | | Ref. | Ref. | Ref. | Ref. |
| | inventive | 125° C. | 155° C. | 125° C. | 155° C. |
| WBM Black B5 | yes | 2.0 | 2.0 | KW1 | KW1 |
| WBM Black B6 | yes | 2.0 | 2.0 | KW1 | KW1 |
| WBM Black B7 | yes | 2.0 | 2.0 | KW1 | KW1 |
| WBM Black B8 | yes | 1.5 | 2.0 | KW1 | KW1 |
| WBM Black B9 | no | 2.5 | 2.5 | KW3 | KW3 |
| WBM Black B10 | no | 2.0 | 2.0 | KW5 | KW5 |

The results again show that using the basecoats of the invention, outstanding adhesion properties are obtained, which, moreover, are better than with the comparative systems.

Overall, the results show that only the basecoat materials of the invention are suitable for providing multicoat paint systems and refinish systems which combine excellent optical and esthetic properties with outstanding adhesion properties.

1. An aqueous basecoat material comprising
at least one aqueous polyurethane-polyurea dispersion (PD) having polyurethane-polyurea particles present in the dispersion with an average particle size of 40 to 2000 nm and a gel fraction of at least 50%, wherein the polyurethane-polyurea particles, in each case in reacted form, comprise
(Z.1.1) at least one polyurethane prepolymer containing isocyanate groups and containing anionic groups and/or groups which can be converted into anionic groups, and (Z.1.2) at least one polyamine containing two primary amino groups and one or two secondary amino group,
and also
at least one aqueous dispersion (wD) comprising a polymer having a particle size of 100 to 500 nm, and prepared by a successive radical emulsion polymerization of three different mixtures (A), (B), and (C), of olefinically unsaturated monomers,
wherein
a polymer prepared from the mixture (A) possesses a glass transition temperature of 10 to 65° C.,
a polymer prepared from the mixture (B) possesses a glass transition temperature of −35 to 15° C.,
and
a polymer prepared from the mixture (C) possesses a glass transition temperature of −50 to 15° C.

2. The aqueous basecoat material as claimed in claim 1, wherein the monomer mixture (A) comprises at least 50 wt % of monomers having a solubility in water of less than 0.5 g/l at 25° C., and the monomer mixture (B) comprises at least one polyunsaturated monomer.

3. The aqueous basecoat material as claimed in claim 1, wherein a fraction of the monomer mixture (A) is from 0.1 to 10 wt %, a fraction of the monomer mixture (B) is from 60 to 80 wt %, and a fraction of the monomer mixture (C) is from 10 to 30 wt %, based in each case on a sum of individual amounts of the mixtures (A), (B), and (C).

4. The aqueous basecoat material as claimed in claim 1, wherein polyolefinically unsaturated monomers present in the monomer mixture (B) are exclusively diolefinically unsaturated monomers.

5. The aqueous basecoat material as claimed in claim 1, wherein the monomer mixtures (A) and (B) contain no hydroxyl-functional monomers and no acid-functional monomers.

6. The aqueous basecoat material as claimed in claim 1, wherein the polyamine (Z.1.2) consists of one or two secondary amino groups, two primary amino groups, and also aliphatically saturated hydrocarbon groups.

7. The aqueous basecoat material as claimed in claim 1, wherein the prepolymer (Z.1.1) comprises at least one polyesterdiol prepared using diols and dicarboxylic acids, wherein, in the preparation of these polyesterdiols, at least 50 wt % of the dicarboxylic acids used are dimer fatty acids.

8. The aqueous basecoat material as claimed in claim 1, wherein the polyurethane-polyurea particles present in the dispersion have an average particle size of 110 to 500 nm and a gel fraction of at least 80%.

9. The aqueous basecoat material as claimed in claim 1, wherein the prepolymer (Z.1.1) contains carboxylic acid groups.

10. The aqueous basecoat material as claimed in claim 1, which further comprises at least one hydroxy-functional polymer, different from the polymers present in the dispersions (wD) and (PD), and also a melamine resin.

11. A method for producing a multicoat paint system, comprising
(1) producing a basecoat film on a substrate or producing two or more directly successive basecoat films on a substrate, by applying an aqueous basecoat material or directly successively applying two or more aqueous basecoat materials to the substrate,
(2) producing a clearcoat film on the basecoat film or on the topmost basecoat film,
(3) jointly curing the basecoat film and the clearcoat film, or the basecoat films and the clearcoat film,
wherein the basecoat material in stage (1), or at least one of the two or more basecoat materials used in stage (1), is a basecoat material as claimed in claim 1.

12. The method as claimed in claim 11, wherein a metallic substrate coated with a cured electrocoat system serves as substrate, and all films applied thereto are jointly cured.

13. A multicoat paint system producible as claimed in claim 11.

14. A refinish method for a multicoat paint system that has defects, the refinish method comprising an implementation of a method as claimed in claim 11 and using as stage (1) substrate the multicoat paint system that has defects.

15. The refinish method as claimed in claim 14, wherein all of the films applied in the method are jointly cured.

16. A refinish system producible by a method as claimed in claim 14.
